(19) United States
(12) Patent Application Publication
(10) Pub. No.: US 2013/0284806 A1
(43) Pub. Date: Oct. 31, 2013

(54) AUTOMATED PURCHASING SYSTEM

(71) Applicant: Ran Margalit, Boulder, CO (US)

(72) Inventor: Ran Margalit, Boulder, CO (US)

(21) Appl. No.: 13/656,534

(22) Filed: Oct. 19, 2012

Related U.S. Application Data
(60) Provisional application No. 61/549,139, filed on Oct. 19, 2011.
(60) Provisional application No. 61/624,062, filed on Apr. 13, 2012.
(60) Provisional application No. 61/692,929, filed on Aug. 24, 2012.

(51) Int. Cl. G06Q 30/06; G01G 19/414

(52) U.S. Cl. CPC G06Q 30/06; G01G 19/414
USPC 235/382; 177/25.15; 177/210 R; 177/1; 177/25.13

(57) ABSTRACT

Disclosed is an automated purchasing system that utilizes wireless purchaser identifier weight sensing shelves that wirelessly communicate with a store server. Purchasers can utilize a wireless identifier that may comprise an RFID or NFC device, such as a smart phone or tablet computer, which is placed in front of the weight sensing shelf and identifies the purchaser. The purchaser can then remove products from the shelves and the store server keeps track of the items removed. The automated purchasing system eliminates the costly and time consuming checkout process in various stores, such as grocery stores, department stores, hardware stores and other similar stores. Locked compartments and access portals can also be accessed. Also disclosed is a weight measuring hanger that comprises a hanger rod. The hanger rod employs a weight sensor that is sufficiently sensitive to detect the removal or addition of a product from the hanger rod.

### CROSS-REFERENCE TO RELATED APPLICATIONS

This application is based upon and claims the benefit of U.S. provisional application No. 61/549,139, entitled “Automated Purchasing System,” filed Oct. 19, 2011, U.S. provisional application No. 61/624,062, entitled “Automated Purchasing System,” filed Apr. 13, 2012, and U.S. provisional application No. 61/692,929, entitled “Automated Purchasing System,” filed Aug. 24, 2012, the entire disclosures of which are herein specifically incorporated by reference for all that they disclose and teach.

### BACKGROUND OF THE INVENTION

Conventional processes for accessing goods, including sources of food and drink, are prevalent in many venues. For example, grocery stores, gas stations, cafeterias, and similar establishments allow a user to directly access and select food. The user then goes to a checkout area and pays for the food. Similar processes are used in many other types of stores for purchasing various types of goods. For example, department stores, hardware stores, auto parts stores, and other types of stores allow a user to select goods and bring them to a cashier to purchase the goods prior to leaving the store. To reduce labor costs, some stores allow the user to automatically scan items and pay by credit card. These processes for purchasing foods and goods has been quite effective, since it allows the user to view and inspect the items prior to purchase.

### SUMMARY OF THE INVENTION

An embodiment of the present invention may therefore comprise a method of purchasing a product from a store using an automated purchasing system comprising: using a weight sensing shelf to display the product, the weight sensing shelf having a wireless identification reader that reads a wireless identifier that is associated with a purchaser; using the wireless identification reader to identify the purchaser when the purchaser places the wireless identifier proximate to the wireless identification reader; using weight sensors in the weight sensing shelf to generate a weight signal that indicates an amount of the product removed from the weight sensing shelf; transmitting the weight signal, that indicates the amount of the product removed from the weight sensing shelf, to a processor; identifying the product and the amount of the product removed from the weight sensing shelf to charge the purchaser for the product removed from the weight sensing shelf.

An embodiment of the present invention may further comprise an automated purchasing system that allows purchasers to select and automatically purchase products from a store comprising: a plurality of weight sensing shelves located in the store that display the products for sale; weight sensors disposed in the weight sensing shelves that generate weight information relating to the products; wireless identifiers that identify the purchasers; wireless identification readers disposed in the weight sensing shelves that read the wireless identifiers placed proximate to the wireless identification readers and generate identification information relating to the purchasers; a processor that receives the weight information and the identification information and charges the purchaser for products removed from the weight sensing shelves based upon the weight information.

An embodiment of the present invention may further comprise a method of purchasing products from a locked compartment using an automated purchasing system comprising: scanning a graphic code on a compartment with a smart communicator; processing the graphic code in the smart communicator using a software application downloaded by the smart communicator to generate a compartment identification code; transmitting the compartment identification code and a user identification code from the smart communicator to a processor; transmitting an unlock code from the processor to the compartment to unlock the compartment; measuring the weight of the products removed from weight shelves in the compartment; identifying the products removed from the weight shelves based upon the weight of the products to generate product identification information; transmitting the product identification information that identifies the products removed from the weight shelves to the processor; charging an account associated with the user identification code for the products removed from the weight shelves.

An embodiment of the present invention may further comprise a method of unlocking an access port using an automated control system comprising: scanning a graphic code disposed proximate to the access port with a smart communicator; processing the graphic code in the smart communicator using a software application to generate a portal identification code; transmitting the portal identification code and a user identification code from the smart communicator to a control center; comparing the portal identification code and the user identification code with a list of authorized portal identification codes and authorized user identification codes; transmitting an unlock code to the portal if the portal identification code and the user identification code match an authorized portal identification code and an authorized user identification code.

An embodiment of the present invention may further comprise a system for purchasing products from a locked compartment comprising: a graphic code associated with the locked compartment that is disposed proximate to the locked compartment; a smart communicator that scans the graphic code; an application program downloaded in the smart communicator that processes the graphic code in the smart communicator and generates a compartment identification code and a user identification code, which are transmitted by the smart communicator; a processor system that receives the compartment identification code and the user identification code and transmits an unlock code if the user identification code and the compartment identification code match a list of authorized user identification codes and authorized compartment identification codes; an electronic lock that receives the unlock code and unlocks the compartment in response to the unlock code; weight shelves disposed in the compartment that measure product weights of products removed from, and replaced on, the weight shelves and transmit product identification information based upon the weight of the products removed from, and replaced on, the weight shelves to the processor system, which charges and credits an account associated with the smart communicator.

An embodiment of the present invention may further comprise a system for purchasing products from a locked compartment comprising: at least one weight shelf disposed in the locked compartment that generates a weight measurement signal that indicates when the products have been removed or replaced on the weight shelf; a camera that records an image for recognition of a user of the locked compartment; a processing system that analyzes the image to produce analyzed image data, compares the analyzed image with stored image data to recognize the user, determines if the user has an authorized account, generates an unlock signal, determines the number and types of products removed from the weight self based upon the weight measurement signal and charges the account of the user for the products removed from the weight shelf; an electronic lock that unlocks a door on the locked compartment to allow the user to access the products in the locked compartment.

An embodiment of the present invention may further comprise a system for unlocking an access port using an automated control system comprising: a graphic code associated with the access port that is disposed at least proximate to the access port; a smart communicator that scans the graphic code; an application program downloaded in the smart communicator that processes the graphic code and generates an access port identification code and a user identification code that are transmitted by the smart communicator; a control center that receives the access port identification code and the user identification code and transmits an unlock code to the access port to unlock the access port if the access port identification code and the user identification code match an authorized access port identification code and an authorized user identification code in an authorized list of access port identification codes and authorized user identification codes.

An embodiment of the present invention may further comprise a weight measuring hanger apparatus for purchasing products comprising: a hanger rod; a bracket having at least one hook so that the at least one hook attaches to a substantially vertical surface; a load cell disposed in the hanger rod that detects the weight of the products on the hanger rod and provides an electrical weight measuring signal that detects removal of the products from the sensor rod; a cover disposed on the weight sensor to protect the at least one load cell.

An embodiment of the present invention may further comprise a method of purchasing products from a weight measuring hanger comprising: providing a hanger rod having a bracket; securing the bracket on a substantially vertical surface using at least one hook disposed on the bracket; providing at least one load cell disposed in a weight sensor, the weight sensor being disposed in the hanger rod and measuring the weight of the products on the hanger rod; detecting removal of the products from the hanger rod by detecting a change in weight of the products on the hanger rod; charging an identified purchaser for the products removed from the hanger rod based upon the change in weight of the products on the hanger rod.

An embodiment of the present invention may further comprise a shelf for measuring weights of products placed on the shelf and generating electronic data indicating the number of products removed and replaced on the shelf comprising: a bottom plate; a plurality of weight sensors that generate an electronic signal that varies with a weight detected by the weight sensors; a top plate that rests on the weight sensors that provides a surface for placing the products; a processor that receives the electronic signal and generates a weight signal indicative of a total weight of products disposed on the top plate.

An embodiment of the present invention may further comprise a shelf that provides multiple weight measurements comprising: a shelf surface plate having a plurality of openings; a plurality of weight sensors attached to the shelf surface plate through the openings; a plurality of weight sensing plates having a first surface that provides a surface for placing items, and a second surface that rests on the plurality of weight sensors; a display unit coupled to the plurality of weight sensors that displays information regarding items removed and replaced on the plurality of weigh sensing plate.

An embodiment of the present invention may further comprise an automated purchasing system that allows purchasers to purchase products from a locked compartment comprising: a plurality of weight sensing shelves disposed in the locked compartment that display the products for sale and generate weight information relating to the products that are removed from the weight sensing shelves; wireless identifiers that identify the purchasers; wireless identification readers that read the wireless identifiers and generate purchase information; a processor that receives the purchaser information and generates an unlock signal based upon the purchaser information, and receives the weight information relating to products removed from the shelves to charge the purchaser for the products removed from the shelves; an electronic lock that receives the unlock signal and unlocks the locked compartment in response to the unlock signal.

An embodiment of the present invention may further comprise a method of purchasing products from a locked compartment comprising: scanning a wireless identifier in front of a wireless identification reader associated with the locked compartment to generate purchaser identification information that identifies a purchaser; processing the purchaser identification information and generating an unlock signal based upon at least the purchaser identification information; transmitting the unlock signal to the compartment to unlock the compartment and allow access to the products placed on weight measuring shelves disposed in the compartment; measuring the weight of the products removed from the weight measuring shelves; identifying products removed from the weight measuring shelves based upon the weight of the products removed from the weight measuring shelves; charging the purchaser for the products removed from the weight measuring shelves.

### BRIEF DESCRIPTION OF THE DRAWINGS

FIG. 1 is a schematic diagram of an architecture of an embodiment of an automated purchasing system.

FIG. 2A is a schematic isometric view of an embodiment of a wireless purchaser identifier weight sensing shelf.

FIG. 2B is a schematic isometric view of the embodiment of the shelf of FIG. 2A with the top plate and front panel removed.

FIG. 3 is a schematic bottom view of the embodiment of the shelf illustrated in FIGS. 2A and 2B.

FIG. 4 is a schematic bottom view of the embodiment of FIGS. 2A, 2B and FIG. 3 with a bottom plate removed.

FIG. 5 is a work flow diagram of an embodiment of the process performed by the wireless user identifier weight sensing shelf.

FIG. 6 is a schematic flow diagram of an embodiment of the manner in which a new purchaser utilizes an automated purchasing system.

FIG. 7 is a flow diagram that discloses an embodiment of the process by which an existing purchaser uses an automated purchasing system.

FIG. 8 is a flow diagram of an embodiment of the manner in which a server registers with the automated purchasing system.

FIG. 9 is a flow diagram illustrating an embodiment of the process by which a wireless user identifier weight sensing shelf registers with a server.

FIG. 10 is a flow diagram illustrating an embodiment of the process for setting up a new wireless user identifier weight sensing shelf.

FIG. 11 is a flow diagram illustrating an embodiment of the process by which a wireless user identifier weight sensing shelf is loaded with product.

FIG. 12 is a schematic isometric view of another embodiment of a wireless purchaser identifier weight sensing shelf.

FIG. 13 is a schematic isometric diagram of an embodiment employing multiple sensing shelves.

FIG. 14 is a schematic isometric bottom view of the multiple sensing shelves of FIG. 13.

FIG. 15 is a close-up view of a weight sensor mounted in the openings of FIG. 13.

FIG. 16 is a close-up view of the top surface of a portion of the shelf surface plate of FIG. 13.

FIG. 17 is a schematic illustration of a coded cooler system.

FIG. 18 is a flow diagram illustrating a compartment unlocking process and charging system.

FIG. 19 is a schematic block diagram of another embodiment of a vending system.

FIG. 20 is a flow diagram of a process for using a vending compartment of FIG. 19 with either an optical pattern recognition or NFC device.

FIG. 21 is a schematic illustration of another embodiment illustrating a door opening system.

FIG. 22 is a flow diagram illustrating the method of the operation for opening doors and other access portals, such as the system illustrated in FIG. 21.

FIG. 22 is a schematic isometric view of another embodiment illustrating a weight measuring hanger.

FIG. 24 is a schematic top view of the weight measuring hanger of FIG. 23.

FIG. 25 is a sectional view of the weight measuring hanger of FIGS. 23 and 24.

FIG. 26 is an end view of the weight measuring hanger of FIG. 23.

FIG. 27 is a sectional view of a load cell used in the weight measuring hanger of FIG. 23.

### DETAILED DESCRIPTION OF THE EMBODIMENTS

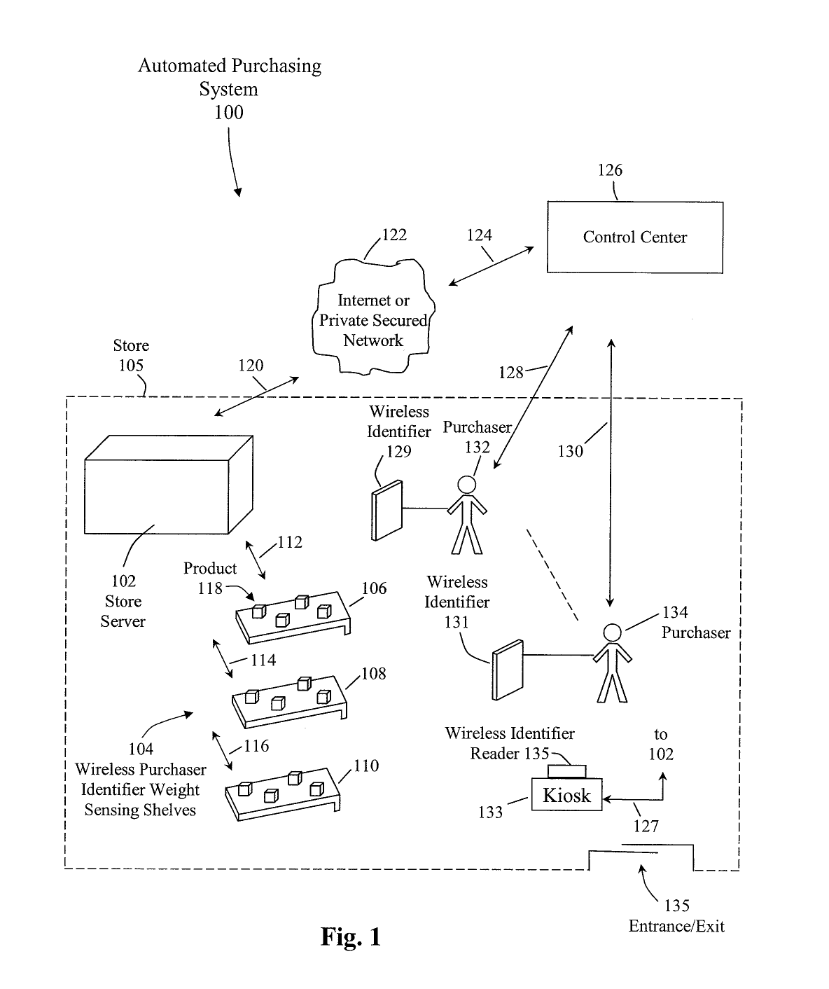

FIG. 1 is a schematic diagram of an embodiment of an automated purchasing system 100. As illustrated in FIG. 1, the automated purchasing system 100 includes a retail store 105 that sells products 118 to purchasers, such as the plurality of purchasers 132, 134. Store 105 also includes at least one kiosk 133 that is placed near the entrance/exit 135. Products for sale are placed on a plurality of wireless purchaser identifier weight sensing shelves 104, such as the plurality of shelves 106, 108, 110. Each of the weight sensing shelves 104 communicates wirelessly with the store server 102. For example, shelf 106 wirelessly communicates with store server 102 over wireless link 112. Shelf 108 wirelessly communicates with store server 102 over wireless link 114. Shelf 110 wirelessly communicates with store server 102 over wireless link 116. Alternatively, the wireless link 116 may also pass through the transceiver in shelf 108 and the wireless link 114 may pass through the transceiver in shelf 106. This manner of linking of the communication paths allows each shelf to be a wireless relay point for the other shelves. Accordingly, the distance of certain shelves in the store from the server no longer becomes a critical issue, since the more distant shelves can be linked to shelves that are closer to the store server 102, so that all the shelves can be in communication with store server 102 no matter how far the shelves are spaced from the store server 102. Shelves 106-110 can also be wired to store server 102. The products 118 that are for sale in the store 105 are placed on the wireless purchaser identifier weight sensing shelves 104.

When a purchaser desires to remove a product from one of the weight sensing shelves 104, the purchaser places or waves a wireless identifier in front of one of the shelves 106-110. The wireless identifier provides information to shelves 106-110 that allows the automated purchasing system 100 to identify the purchaser. The identification of the purchaser may occur at one of the shelves 106-110, the store server 102, or at the control center 126. The control center 126 may be operated as a private computing system, or on processing systems that operate on the rented computing assets on the Internet cloud. In either case, control center 126 can be browser friendly for full operational aspects of the control center 126. Control center 126 may be a web-enabled or web-hosted system that can be accessed by an Internet browser. Alternatively, the control center 126 may constitute a private computing system that may be either browser-based or accessible using other means.

In order to remove product from the shelves 106-110, as illustrated in FIG. 1, each of the purchasers has a wireless identifier 129, 131, which may comprise a near field communication (NFC) device, a radio frequency identifier (RFID), or an optically coded object, which is recognized using optical recognition techniques, all of which are collectively referred to herein as wireless identifiers. Other embodiments disclosed herein do not require the use of a wireless identifier and may simply use optical facial recognition. As shown in FIG. 1, purchaser 132 has a wireless identifier 129. Purchaser 134 has a wireless identifier 131. The wireless identifier may comprise an active or passive RFID card, in accordance with one embodiment. As disclosed above, the wireless identifier may constitute a near field communication (NFC) device or other electronic device for identifying the purchaser. For example, smart phones may include a near field communication (NFC) chip, which allow for data exchange and wireless connections between two devices in close proximity to each other, usually spaced by no more than about four inches. Smart phones may also store credit card, or other account, information that can be transmitted using an embedded NFC chip.

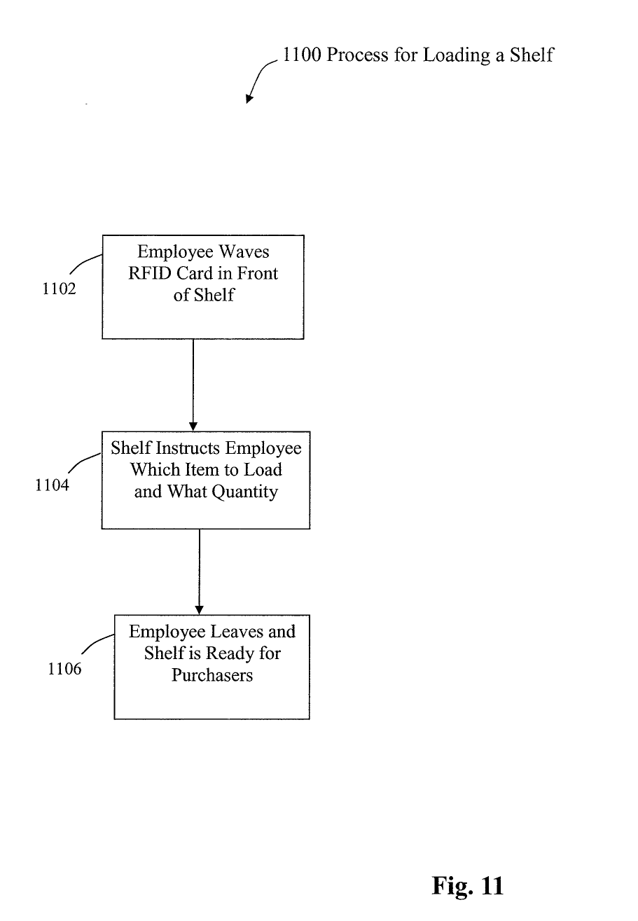

As illustrated in FIG. 1, a purchaser, such as purchaser 132, that wishes to remove a product 118 from a shelf, such as shelf 106, and purchase that item, simply places the wireless identifier 129 next to the weight sensing shelf 106. A display on the weight sensing shelf 106 may indicate that the purchaser 132 has been identified. The purchaser 132 can then remove one or more products from the shelf 106. The shelf 106 carefully senses the weight of the products 118 on the shelf 106 and can calculate the number of products removed by purchaser 132, since shelf 106 is also programmed with the weight of each individual product. Accordingly, since the shelf is capable of sensing the weight of the products, and knows the weight of each of the products, the shelf can determine how many products the purchaser 132 has removed from the shelf 106. Similarly, if purchaser 132 has decided to return a product, purchaser 132 can waive the wireless identifier 129 in front of a shelf, such as shelf 106, and replace a product on the shelf. Again, since the shelf 106 knows the weight of each of the products, shelf 106 can determine how many products 118 have been returned to the shelf 106. Alternatively, the shelves 106-110 may simply provide the weight measurements to store server 102 via links 112, 114, 116. Store server 102 can then calculate the amount or number of products that have been placed on, or removed from, the shelves 106-110. These amounts may also be stored in the control center 126, that can also calculate the amount of product removed or replaced on the shelves 106-110. In that regard, the processors in shelves 106-110 do not have to be reprogrammed each time a product is changed for placement on shelves 106-110. Rather, the store server 102, or web-based purchasing control system 126, can perform those calculations and store information relating to the product, including the weight, price and other information. Information relating to the product can be stored in the server by a store administrator, or in the control center 126 by an administrator of the automated purchasing system 100, during a setup process, in accordance with the process illustrated in FIG. 11, as explained in more detail below.

All of the information gathered by the shelf 106, such as the identification of the purchaser, as well as the number of products removed or replaced on shelf 106, is transmitted to a store server 102 via a wireless communication link 112, as illustrated in FIG. 1, or a wired link. Store server 102 then tabulates the products removed by each of the purchasers 132-134 based upon the data received over the plurality of wireless links 112, 114, 116. This process may also be performed in control center 126. Each of the plurality of purchasers 132, 134 may receive a free wireless identifier, such as a free RFID card, or may have to pay or provide a deposit for an RFID card, when entering the store 105. As disclosed below, the RFID cards can be associated with a credit card, or may comprise prepaid RFID cards that are loaded with a certain amount of money that is paid in cash, or transferred from a credit or debit card, or an account, by the purchaser to a clerk or kiosk 133 when entering the store. Similar procedures may be used with NFC devices.

As also illustrated in FIG. 1, the store server gathers all of the information tabulated for each of the purchasers 132, 134 for the products 118 removed from the plurality of shelves 106-110, and transmits this information over the Internet or secured private network 122 via links 120, 124 to a web based purchasing control system 126. The web based purchasing control system 126 collects the information and, in accordance with one embodiment, may wirelessly transmit this information to the plurality of purchasers 132, 134 over links 128, 130. Links 128, 130 may constitute wireless data links that are used by smart phones or other devices, such as tablet computers. Hence, purchasers 132, 134 that are equipped with NFC devices, such as smart phones or tablet computers, having embedded near field communication (NFC) chips, may simply register at kiosk 133 and proceed through the store and remove products 118 from any one of the numerous shelves 106-110 by simply placing the NFC device near the front panel 138 of the shelves 106-110. The purchaser may also download an application for the purchaser's smart communicator, which may be a smart phone, tablet computer or similar device, that registers the purchaser with the purchasing control system 126. The purchaser can then enter any store that is registered with the purchasing control system 126 and purchase products without registering at the kiosk 133. Also, the purchaser may register a smart phone, tablet computer, or other interactive device, with the purchasing control system 126 and receive downloads indicating products that have been selected using any type of identification system.

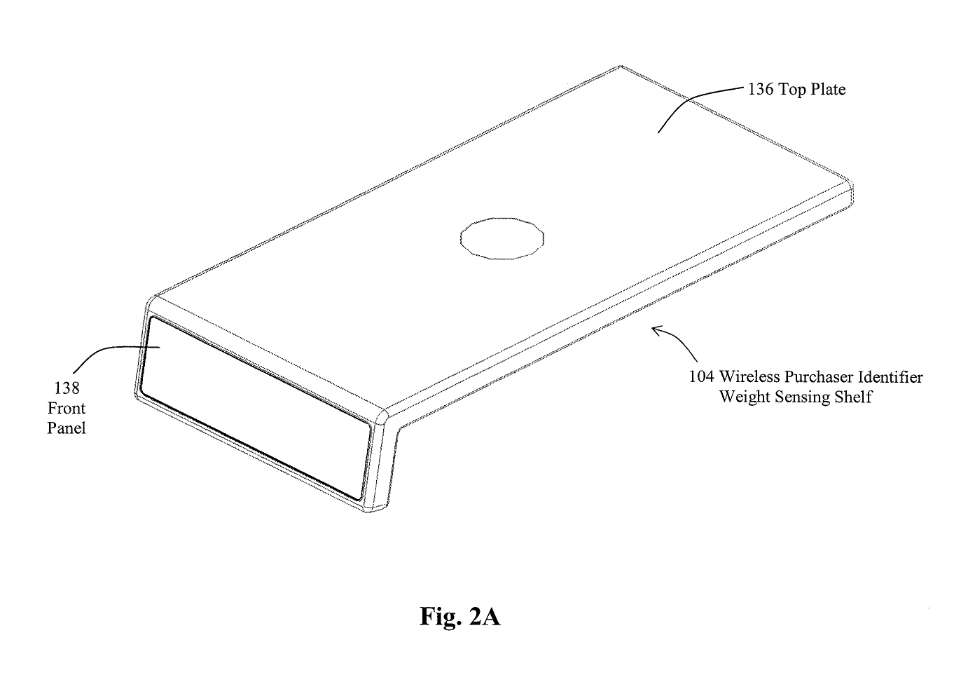

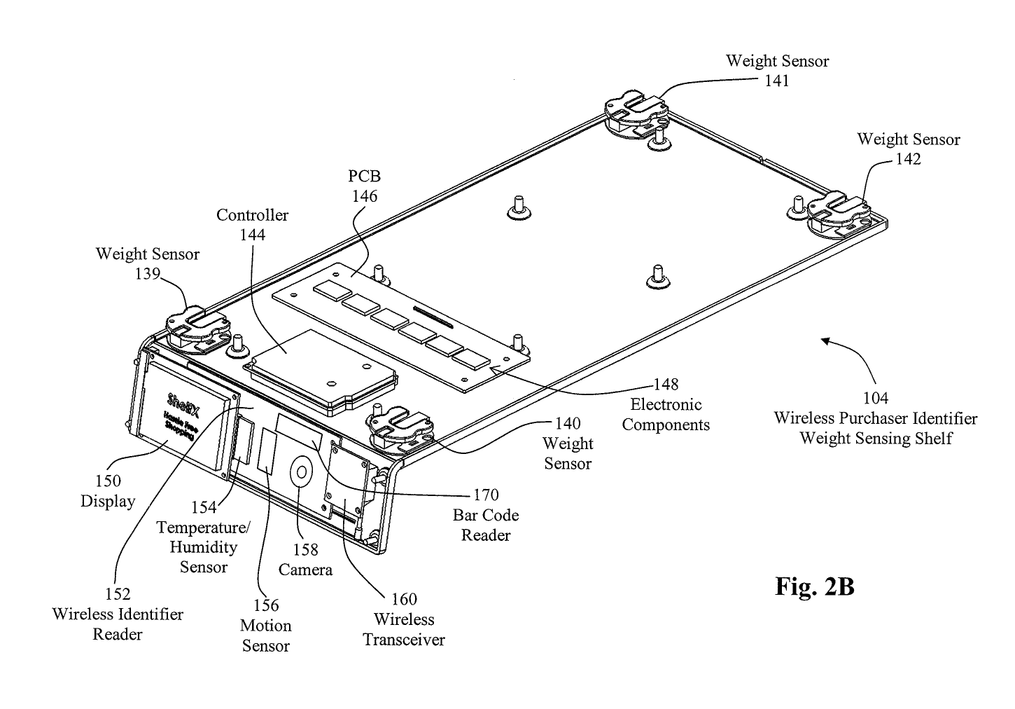

The purchaser's account may be associated with a credit card, debit card, bank account, or other systems for paying, including, but not limited by way of illustration, PayPal, or other pay system or account. An optional kiosk 133, illustrated in FIG. 1, is linked via link 127 to the store server 102. When a customer leaves, the customer places the wireless identifier 129, 131 adjacent the wireless identifier reader on kiosk 133. For example, purchaser 132 may place wireless identifier 129 next to a wireless identifier reader 135 (FIG. 2B) on kiosk 133. The kiosk then displays the products that have been tabulated for the purchaser 132. The purchaser can review these products to see if these products match the products in the purchaser's cart. A store security clerk may also be present, if desired by the store owner, to compare the displayed items with the items in the purchaser's cart. If they correspond, the purchaser may then exit the entrance/exit 135. In this manner, the numerous store cashiers and checkout procedures in grocery stores and other types of stores can be eliminated. Further, the space required for checkout counters, conveyors and the other equipment associated with checkout counters, as well as the employees required to operate the checkout counters, can be eliminated. This greatly reduces labor costs and capital equipment costs.

As also disclosed in FIG. 1, the wireless links between the web based purchasing control system 126 and the purchasers 132, 134, such as links 128, 130, allow the purchasers 132, 134 to keep track of purchased items, as the products 118 are removed by the purchaser from the shelves, on a smart phone, ultramobile computer, tablet computer, such as an iPad, or other interactive handheld electronic device, collectively referred to herein as “smart communicators.” In this manner, purchasers can be assured that the proper items are being tabulated in their account while the purchasers 132, 134 are in the store 105, so that a final tabulation at kiosk 133 can proceed more rapidly. For example, a smart communicator may include an application that links the smart communicator to the web based purchasing control system 126, so that purchasers can keep track of the items purchased. Smart communicators that have an embedded NFC chip can provide the functions of both a wireless identifier and the product monitoring functions for the products 118 that are placed in the tabulated purchaser's account. Further, if the purchaser's account is linked to a credit card, debit card, or other account, the purchaser can be immediately notified by the web based purchasing control system 126 if there is a problem with the account. For example, if a purchaser 132 enters the store 105 and uses a smart communicator that is linked to a credit, debit or other account, and the purchaser removes an item from a shelf, the control center 126 can immediately notify the purchaser 132 via link 128 of any problems without the account. At a point, the purchaser can go to the kiosk 133 and link the smart communicator to another account, rather than wasting time going through the entire store and only learning at checkout that there is a problem with the account. If the purchaser 132 uses an RFID card, or an NFC device that is not a smart communicator, the purchaser may be notified through the display on one of the shelves 106-110 to go to the kiosk 133 when there is a problem with the account, or if the balance on the card is not sufficient, or may be simply notified by the display on the shelf that the funds in the account are low, or that the balance on the card is low. That process may also reduce embarrassment for the purchaser if a problem does exist on the account, since the purchaser does not have to go through a process at the time the purchaser leaves the store of linking to different accounts or returning products. For example, when using an NFC device that has an embedded NFC chip, the purchaser may enter the store, place the NFC device next to a shelf for identification, and remove an item from the shelf. If there is a problem with the account, the web based purchasing control system 126 will display a notification, such as “Proceed to Kiosk” or “See Customer Service.” Also, the purchaser may place a smart communicator next to the wireless identifier reader 135 located at kiosk 133 when entering the store to ensure that no problems exist with the account, or to obtain a balance on the account, which can be displayed either on the kiosk 133, or on the smart communicator. Alternatively, an RFID card can be waved in front of the wireless identification reader 135 at the kiosk 133 upon entering the store. The user can insert cash into the kiosk 133 to load the RFID card with funds that are stored on the card, or in an account associated with the card. Store server 102 may track the funds in the account. Funds may also be loaded into a smart communicator or an account associated with a smart communicator. A credit or debit card can also be used in the kiosk 133 to load an RFID or a smart communicator with funds from a credit or debit card. While shopping, the store server 102 may track the funds in the RFID card or smart communicator and provide a balance to the user on displays on the shelves 106-110. Of course, the user may also use the kiosk 133 to check for the balance of the funds on either the RFID card or smart communicator. The automated purchasing system 100 may be designed so that the purchase of goods can only be performed with an RFID card or a smart communicator that has a positive balance of funds loaded onto the RFID device or smart communicator.

A purchaser may also wish to prepare a food item list, or other product list, which is referred to herein as a shopping list, prior to going to the store 105. In that case, the user may logon to the purchasing control system 126 using an application and generate the shopping list. The shopping list can be compared automatically with the retrieved items by the web based purchasing control system 126 to ensure that all of the items on the list are selected. In that regard, a spouse or other person may wish to logon to the web based purchasing control system 126 and modify the list while the purchaser is at the store. In that manner, the purchaser can be assured of purchasing all of the items on the list. Alternatively, items on the shopping list may be manually removed by a user. Further, the shopping list may be accessible by two or more purchasers that can simultaneously update the list. For example, a husband and wife may be separately shopping in a store and as items are purchased, the items are either automatically or manually removed from the shopping list, so that the shopping list is instantaneously updated. In this manner, there is no duplication of effort and the shopping procedure can move forward in an expedited manner.

FIG. 2A is a schematic isometric view of an embodiment of a wireless purchaser identifier weight sensing shelf 104. The wireless purchaser identifier weight sensing shelf 104 includes a top plate 136 and a front panel 138. Additionally, various electronics and various receivers are packaged in the structure of the wireless purchaser identifier weight sensing shelf 104. For example, the front panel 138 may include a display 150 (FIG. 2B) that displays the name of the product, the price of the product and the identity of a purchaser after the purchaser has placed the wireless identifier, such as wireless identifier 129, adjacent to the front panel 138. In more basic implementations, LEDs can be used. For example, a green LED can be used to show that a user has been identified and that products 118 can be removed from the shelf 104. A red LED may indicate the opposite. As indicated above, a store 105 can contain a plurality of shelves 106-110 that have a plurality of products. The shelves 104 can be made of different widths to carry a different number of products. Store server 102 (FIG. 1) may be coupled to a wide band receiver that is capable of receiving tens of thousands of wireless links 112-116 from tens of thousands of shelves 106-110. Each of the links 112-116 is encoded for each of the shelves 106-110, so that the store server 102 can identify the particular shelf 106-110 that is associated with a particular product 118. For example, a typical grocery store will include 15,000 to 20,000 different products.

The wireless purchaser identifier weight sensing shelf 104, illustrated in FIG. 2A, may include an alarm, so that if product is removed from the shelf 104, and a wireless identifier 129 has not been placed adjacent to the shelf 104 and a purchaser has not been identified, an alarm will sound to remind the purchaser to use the wireless identifier to identify the purchaser. The alarm also assists in preventing theft. The wireless purchaser identifier weight sensing shelf 104 can also take a picture of the user, using a camera 158. Other adjacent shelves may also take pictures, including shelves on opposite sides of the isle, to get a rear shot of the purchaser. Security may then be alerted by the store server 102 indicating the location of the shelf, so that security can travel to that location and assist the purchaser, if necessary, or catch a thief.

FIG. 2B is a schematic isometric view of the wireless purchaser identifier weight sensing shelf 104 with the top plate 136 and front panel 138 removed. As illustrated in FIG. 2B, there are four weight sensors 139, 140, 141 and 142 at the corners of the flat, horizontal portion of the shelf 104. Another sensor can also be added to the center of the shelf 104. Each of these weight sensors 139-142 provides a very precise weight measurement that is encoded in an electrical signal that is sent to controller 144. For example, load cells can be used as the weight sensors that have a high degree of accuracy. Printed circuit board 146 is coupled to the various components of the wireless purchaser identifier weight sensing shelf 104 and includes various electronic components, including amplifiers, filters, signal conditioners, a power supply, a voltage regulator and other standard components utilized by the system of the shelf 104. The front portion of the shelf 104 includes a display 150, as disclosed above, that may display various information, including the identity and price of the products placed on the top plate 136. Other information can also be displayed on display 150, such as “user identified,” “see customer service,” “proceed to kiosk,” “two bottles of hot sauce removed,” or “one bottle of hot sauce replaced.” Any useful information regarding the system can also be displayed on the display 150.

Shelf 104, illustrated in FIG. 2B, also includes a wireless identifier reader 152. The wireless identifier reader can read RFID cards, NFC communications and/or other protocols which can identify the user and provide information, such as coding for credit and debit cards, or other information to associate an account with the user. Temperature and humidity sensor 154 provides temperature and humidity information at the shelf 104. A temperature map can then be created for the entire store to indicate temperatures throughout the store. For example, if refrigeration or air conditioning in a certain part of the store 105 has ceased working, the temperature sensor can provide information to the store server 102, so that a repairman can be dispatched. Also, if the sun is shining through a window onto the shelf 104, the temperature on the shelf can be detected, so that temperature sensitive products, such as chocolate, may be placed in other locations, or other remedial action can be taken. Also, motion sensor 156 detects the presence of individuals in front of the shelf 104. Motion data from motion data sensor 156 can be used to monitor traffic within the store. Camera 158 can provide still shots or video of purchasers or thieves. This recorded information can then be used by security, if needed. The wireless transceiver 160 is a small, low power digital transceiver that communicates with store server 102. For example, wireless transceiver 160 may conform to the ZigBee specification to provide high level communication protocols based on the IEEE 802 standard for personal area networks. Other protocols, such as bluetooth, can also be utilized. The ZigBee specification is a radio-frequency application that has a low data rate, low power requirements, and security networking. ZigBee has a defined rate of 250 KBPS, which is well suited for periodic or intermittent data, or single signal transmissions from a sensor device. Other WPAN protocols can also be utilized. Bar code reader 170 may also be provided on the front panel 138. Bar code reader 170 can read bar codes of products, which may assist in programming the wireless purchaser identifier weight sensing shelf 104 during the loading process, such as described with respect to FIG. 11. In addition, purchasers may be issued a bar code or other code, rather than using an RFID card to identify the buyer. For example, codes, such as QR codes, can be issued to individuals, or other different types of codes, which can be read either by the bar code reader 170, or the camera 158, to identify the purchaser. Use of bar codes, QR codes, or similar codes that can be printed on paper is substantially less expensive than using active RFID cards and NFC devices.

As also shown in FIG. 2B, controller 144 controls the transmission of data to the store server 102. In addition, controller 144 is coupled to display 150, temperature/humidity sensor 154, wireless identifier reader 152, motion sensor 156, camera 158, bar code reader 170, and wireless transceiver 160. Controller 144 also receives the encoded electrical signals from the weight sensors 139-142 to calculate the weight changes detected by the wireless purchaser identifier weight sensing shelf 104, which can be related to the items taken from, or replaced on, weight sensing shelf 104. Since there are four separate weight sensors, 139, 140, 141 and 142, controller 144 can not only determine how many products are on the shelf 104, but also where the products are located on the shelf. In that regard, controller 144 may be programmed so that various different products can be placed on a single shelf 104. For example, two, three, or more, different products, having different weights, may be placed on a single shelf 104. Weight sensors 139-142 can identify where products are placed and the location from which products are removed on shelf 104 using a simple linear proportional equation. Accordingly, not only can the controller 144 provide information regarding the identity of a product, as determined by the weight of the product, when there are multiple products on a single shelf 104, controller 144 can provide information to store server 102 indicating the location of the products so that products can be moved to different locations on the shelf 104, such as toward the front of the shelf 104. Alternatively, all four weight sensors may be tied together, which gives a greater range of weight for the products placed on the shelf. Very accurate readings can be obtained using multiple sensors. It should also be noted that the shelf 104 can be mounted so that it has a slight slope and a barrier can be provided on the front portion of the shelf 104, so that products automatically move toward the front of the shelf as a result of gravitational forces.

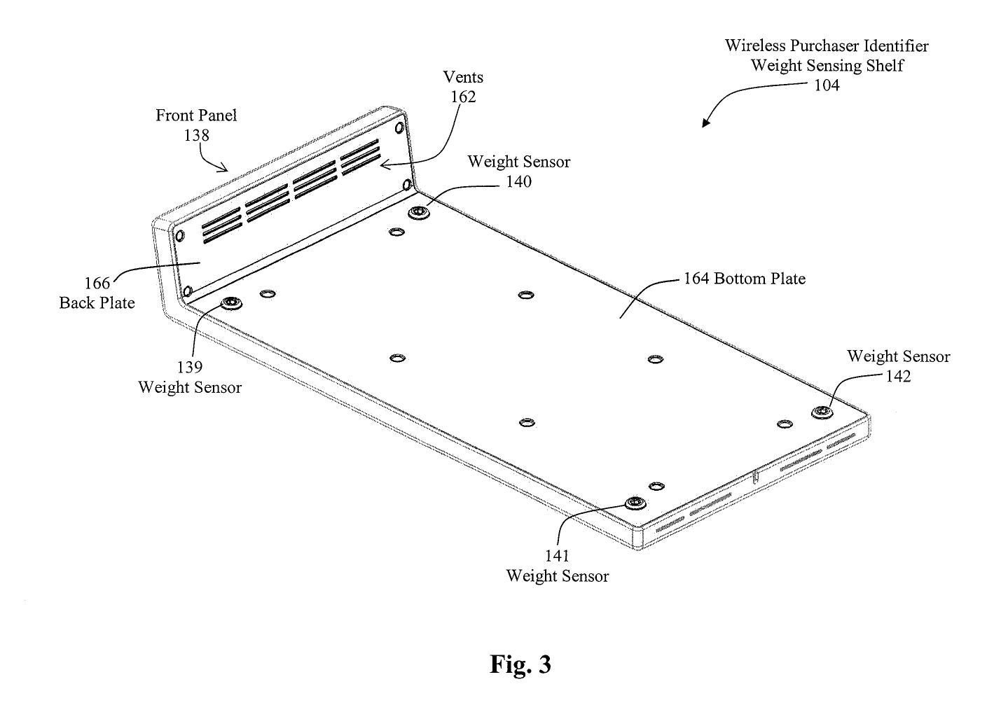

FIG. 3 is a schematic bottom view of the embodiment of the wireless user identifier weight sensing shelf 104, illustrated in FIGS. 2A and 2B. As shown in FIG. 3, bottom plate 164 is secured to the bottom of the shelf 104 and provides openings for weight sensors 139-142. Weight sensors 139-142 rest on a shelf support and provide the highly accurate weight information produced by the shelf 104. Weight sensors 139-142 may comprise load cells. Back plate 166 includes vents 162 that vent the heat from the various electrical components disposed on the shelf 104. Back plate 166 is attached directly behind the front panel 138. A power connector (not shown), is also coupled to the shelf 104. A battery backup system can also be used in association with the weight sensing shelf 104.

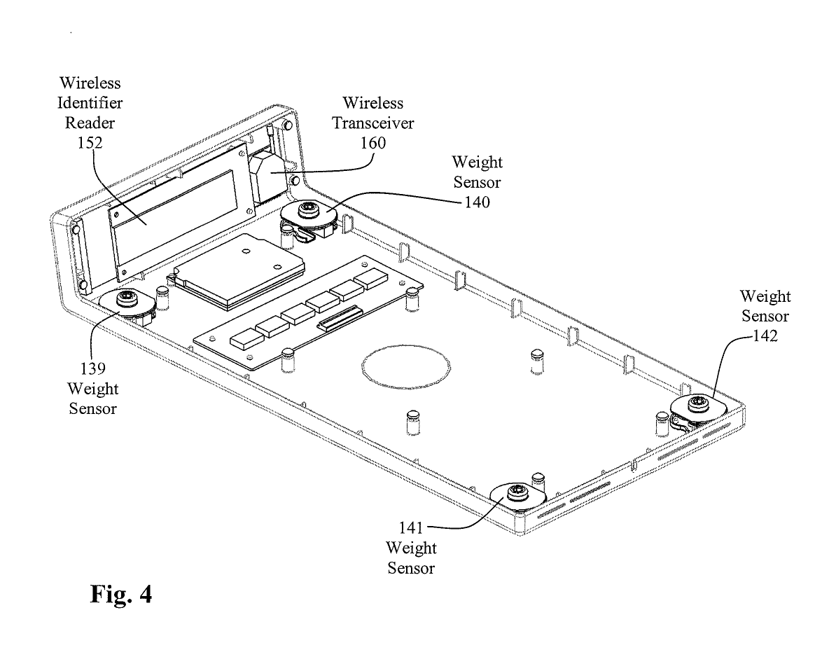

FIG. 4 is a schematic bottom view of the embodiment of the shelf 104 illustrated in FIGS. 2A, 2B and FIG. 3. As illustrated in FIG. 4, weight sensors 139-142 are disposed on the interior portion of the shelf 104 and have protruding legs that rest on a shelf support. FIG. 4 also illustrates the wireless identifier reader 152 and the wireless transceiver 160.

The automated purchasing system 100, illustrated in FIG. 1, can be implemented as a hybrid system in store 105 in which only some of the products are implemented with the shelves 104. For example, a gas station may wish to provide sandwiches from a cooler, so that a purchaser can remove the pre-made sandwiches and proceed directly from the store. Fast food restaurants may wish to have premade lunches which a purchaser can remove from a shelf and not have to wait in a checkout line. In each of these cases, the remaining portion of the store can operate as a normal store.

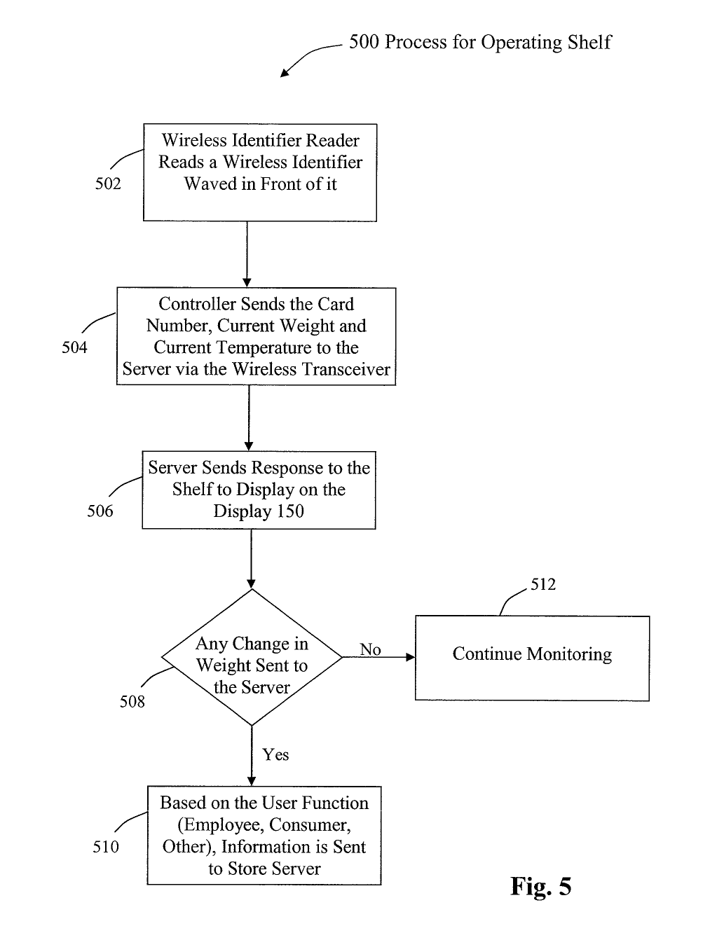

FIG. 5 is a schematic work diagram of a process 500 for operating the shelf 104. At step 502, the wireless identifier reader 152 reads the wireless identifier, which may be an RFID card or a near field communication transmission from a smart phone, tablet computer, etc. which is placed in close proximity to the wireless purchaser identifier weight sensing shelf 104. Optical recognition techniques can also be used as explained herein. At step 504, controller 144 transmits identifying information, such as an RFID card number or NFC identifying information, current weight and current temperature to store server 102 via the wireless transceiver 160. At step 506, the store server 102 sends a response back to the shelf to generate a message on display 150 of shelf 104 indicating the number of products that have been removed from the shelf 104. These transmissions are communicated by a wireless transceiver on store sensor 102, through one of the wireless links 112, 114, 116 to shelves 106, 108, 110 using the wireless transceiver 160 on weight sensing shelf 104. This transmission may also be through a wired link. Other information may also be sent to the display depending upon the function initiated. For example, as disclosed below, an employee may be loading a shelf with product, or linking a shelf to the store server 102. In that case, other information may be generated, such as “link established,” “product loaded,” or the number of products that are loaded. At step 508, the shelf 104 determines if there are any changes in the weight that is sent to the store server 102. If not, the shelf 104 continues to monitor the weight at step 512. If there is a change in weight, the information is sent to the server at step 510.

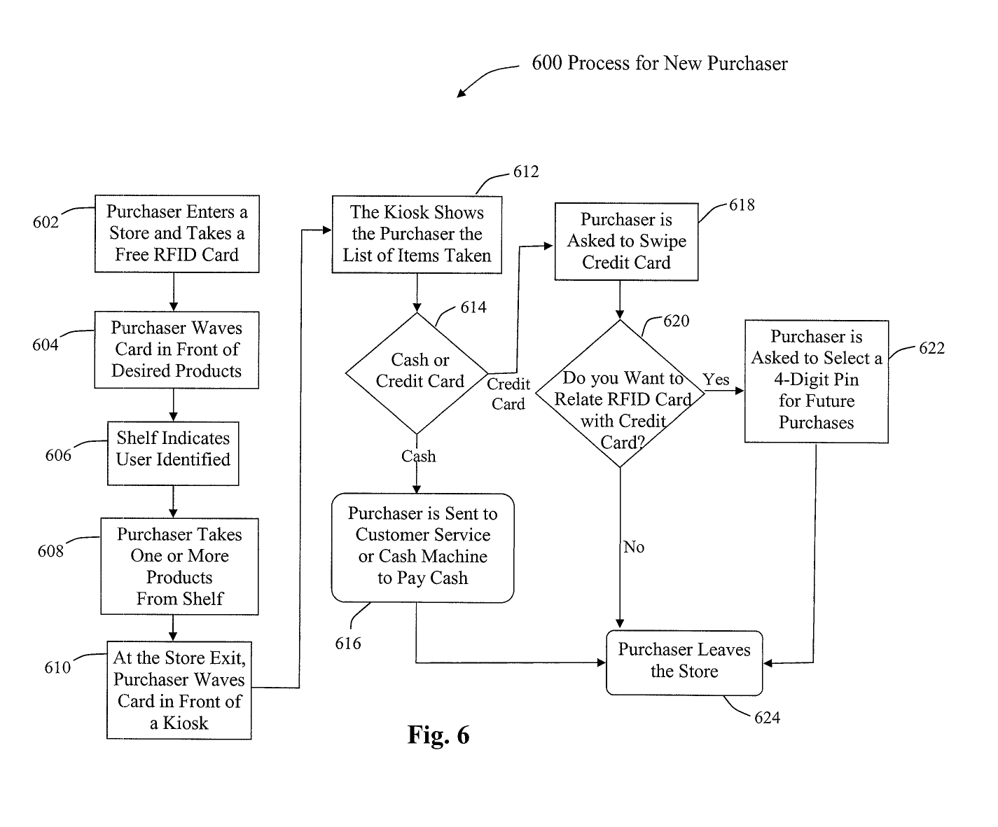

FIG. 6 is an embodiment of a process 600 for a new purchaser. At step 602, a new purchaser enters the store and obtains an RFID card. Alternatively, a new purchaser has an NFC device that includes an NFC chip. A user may also obtain an optical ID or have his or her face scanned for optical facial recognition. At step 604, the new purchaser waves the RFID card in front of a shelf 104 that contains the desired products. Alternatively, a purchaser with an NFC device with an embedded NFC chip registers with the web based purchasing control system 126. This may occur by downloading an application from the web based purchasing control system 126 on the NFC device. Once the NFC device is registered with the web based purchasing control system 126, the NFC device is placed within several centimeters of the shelf 104, so that the shelf 104 identifies the purchaser. Also, a user may press a button or come within a certain distance of the camera 158 mounted on the shelf and display an optical identifier or look into the camera for optical facial recognition. At step 606, the shelf displays a message indicating that the user has been identified. This can simply be done by illuminating a green LED and extinguishing a red LED on front panel 138, or displaying the words “user identified.” At step 608, the purchaser can then take one or more products from the shelf 104. Once the purchaser has taken the products that the purchaser desires, the purchaser proceeds to the store exit at step 610. The purchaser then waves the RFID card next to an RFID reader in kiosk 133. Alternatively, the purchaser places a registered NFC device next to a near field communication (NFC) reader in kiosk 133. Further, the purchase can display an optically coded ID card or face a camera in the kiosk for facial recognition. At step 612, the kiosk 133 displays to the purchaser the tabulated list of products 118 that have been removed from the shelves 104. The kiosk 133 may display “Cash or Credit Card?” to the purchaser at step 614. If the purchaser selects “cash,” the kiosk 133 can accept cash, or the purchaser can be sent to customer service at step 616. Alternatively, the purchaser's account that is associated with the purchaser can be automatically charged. The purchaser then leaves the store at step 624 after paying cash. If a credit or debit card is selected, the purchaser is asked to swipe the card at step 618. Alternatively, if the purchaser is using an NFC device, optical ID, facial recognition, etc., charges may be processed directly to the account or card that is associated with the NFC device. At step 620, the kiosk 133 asks the purchaser if the purchaser wants to associate an RFID card with a credit card, debit card, or other account. If not, the purchaser simply leaves the store at step 614. If the purchaser does desire to associate the RFID card with a credit card, debit card, or other account identified at step 618, the purchaser is asked to select a 4-digit pin at step 622 for future purchases. The process then proceeds to step 624 and the purchaser leaves the store.

In an alternative scenario, a first time purchaser enters a store, such as store 105, and proceeds to the kiosk 133. The first time purchaser swipes a credit or debit card at the kiosk to create an account. The first time customer is then issued an RFID card with funds from the credit card account that are loaded onto the RFID card. Alternatively, funds from the credit or debit card can be loaded onto an NFC device. The first time purchaser may also be given the option of an automatic loading feature, which loads the RFID card or the NFC device with funds whenever the account balance of the store account goes below a given value. For example, if the store account goes below $5.00, the auto load feature may load the store account on the RFID card or NFC device with $50.00. In this manner, the purchaser is not required to continuously reload the RFID card, so that fixed fees for transfers from a credit or debit card are minimized, since transfer of funds only occurs when needed and in an amount that does not result in a large number of microtransfers, which would drive up the fixed credit card processing fees.

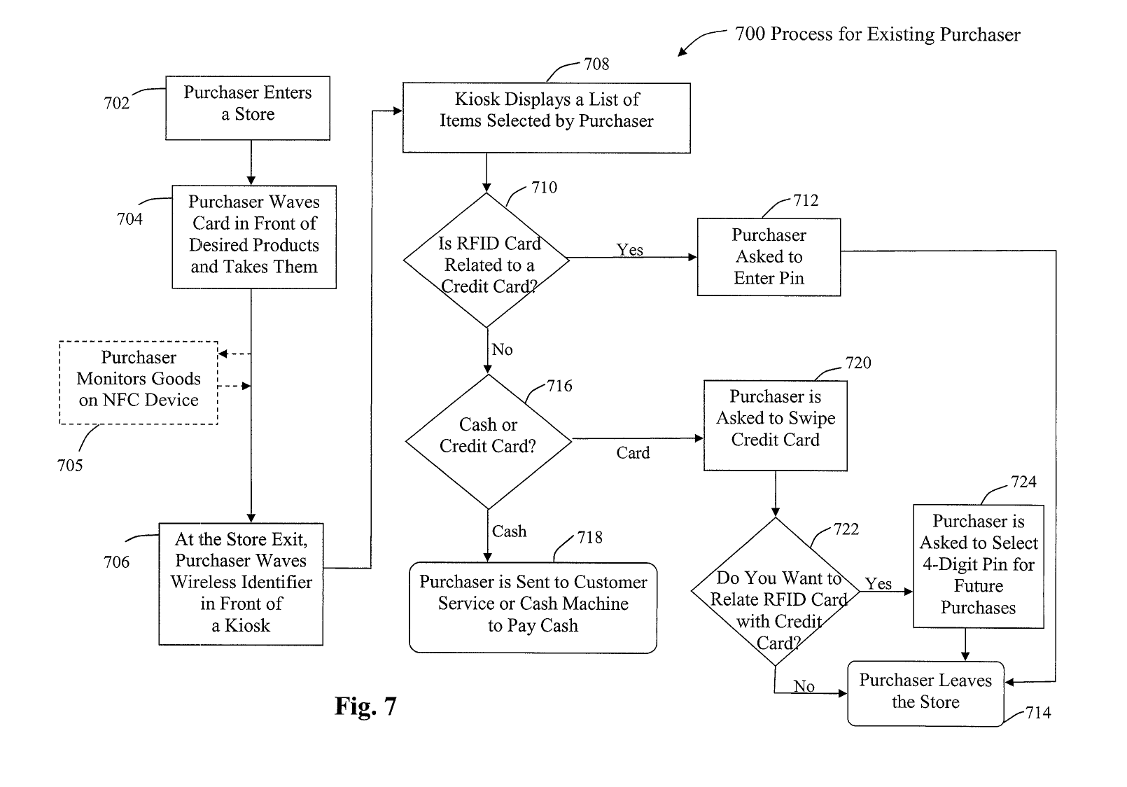

FIG. 7 is a block diagram that illustrates the process 700 for processing transactions of an existing purchaser. At step 702, the purchaser enters the store. At step 704, the purchaser waves an RFID card or places an enabled NFC device in front of a shelf that contains the desired products and takes those products from the shelf. Alternatively, optical recognition techniques can also be used, as disclosed above. At optional step 705, the purchaser can monitor the selected products on a smart communicator if the smart communicator is running an application available from the purchasing control system 126. At step 706, the purchaser waves the RFID card, or places the NFC device in front of a kiosk 133 located near the entrance/exit 135. Also, optical recognition techniques can be used, as disclosed above. At step 708, the kiosk displays the list of items taken by the purchaser. The purchaser may also be given the option of printing the list or emailing the list. At step 710, the kiosk determines if the RFID card is linked to a credit or debit card, or another account. Similarly, the kiosk can determine if the NFC device is linked to a credit or debit card, or another account. If it is, the purchaser is requested to enter a pin at step 712. The process then proceeds to step 714 and the purchaser leaves the store. If the RFID card or NFC device is not linked to a credit or debit card, a bank account or other account, the kiosk 133 prompts the purchaser as to whether the purchaser would like to pay cash or pay by credit, debit or through a bank account, as set forth in step 716. If the user selects cash, the process proceeds to step 718. At step 718, the purchaser is sent to the customer service desk to pay cash, or the kiosk can be used to accept cash payments. At step 716, if the user selects a credit card, debit card or bank account, the process proceeds to step 720. At step 720, the purchaser is asked to swipe the card or enter an account number for a bank account. At step 722, the kiosk 133 asks the purchaser if the purchaser would like to link the credit card, debit card or account number to the RFID card, the NFC device, or an optical identifier. If not, the process proceeds to step 714 and the purchaser leaves the store. If the purchaser answers yes, the purchaser is asked to select a 4-digit pin to confirm future purchases at step 724. The process then proceeds to step 714 and the purchaser leaves the store. Alternatively, the purchaser can purchase a prepaid card at the kiosk upon entering the store and add money to the card at the kiosk at any future time, thereby simplifying the checkout process.

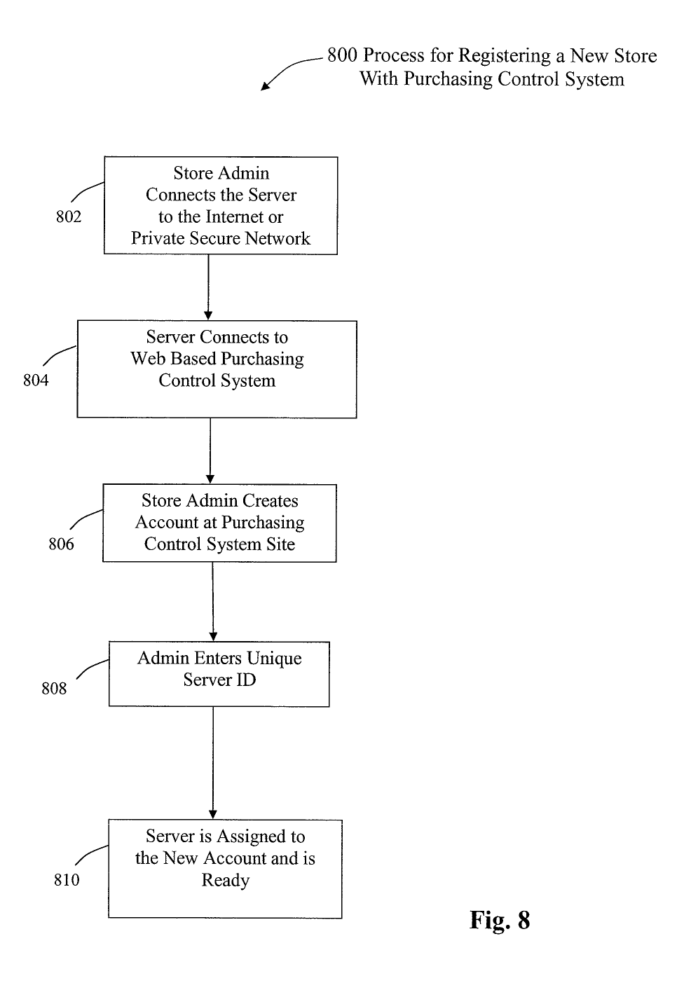

FIG. 8 is a block diagram illustrating an embodiment of a process 800 for registering a new store with the web based purchasing control system 126. At step 802, the store administrator connects the store server 102 to the Internet or to a private secured network 122. At step 804, the server connects to the web based purchasing control system 126. At step 806, the store administrator creates an account with the purchasing control system site. At step 808, the administrator enters a unique server ID. At step 810, the server is assigned to a new account and is ready for operation.

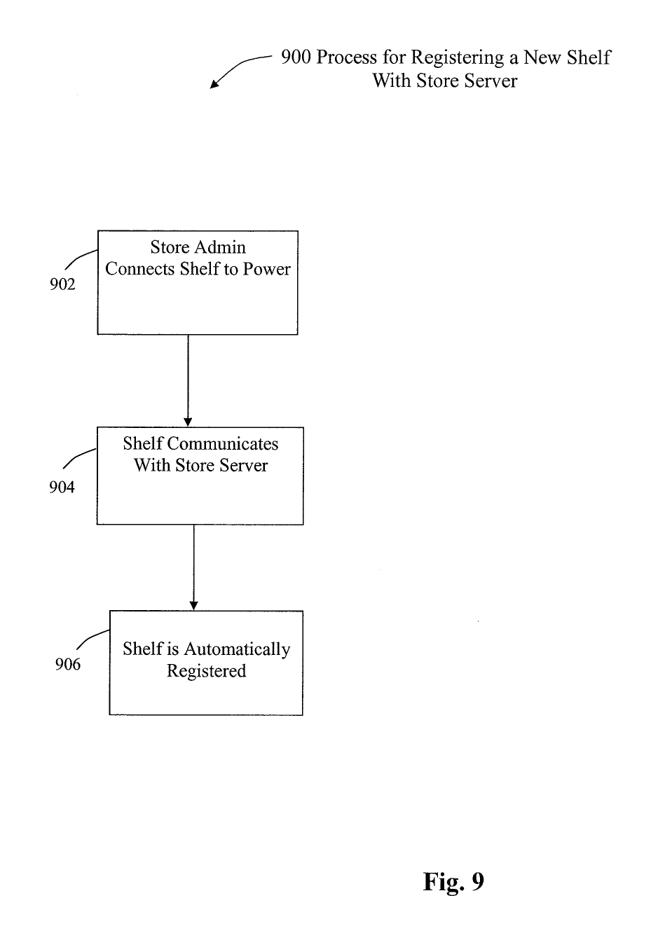

FIG. 9 is a block diagram illustrating an embodiment of a process 900 for registering a new shelf with a store server. At step 902, the store administrator connects the shelf to a power supply. At step 904, the shelf communicates with the store server using wireless links, such as wireless links 112-116. At step 906, the shelf is automatically registered with the store server 102.

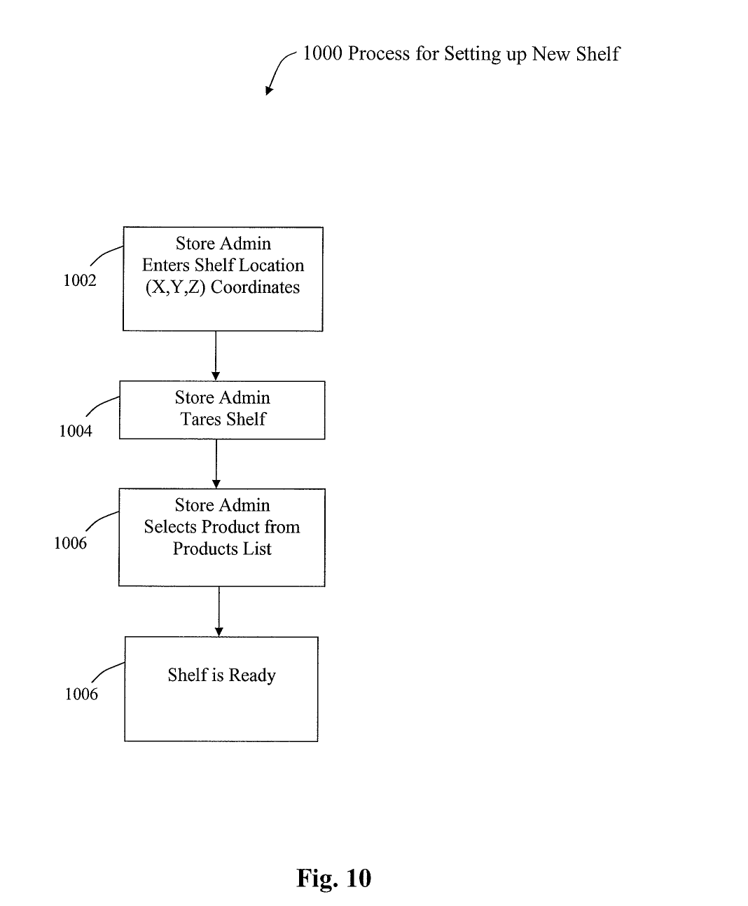

FIG. 10 is an embodiment of a process 1000 for setting up a new shelf. At step 1002, the store administrator enters the shelf location using three dimensional coordinates. These coordinates may be an isle number, a section number, and a shelf height number. At step 1004, the administrator tares the shelf by placing a known weight, such as one pound, on the shelf, so that the shelf can be accurately calibrated. At step 1006, the store administrator selects products to be placed on the shelf from a product list stored in store server 102. When loading the shelf from the product list, the store administrator may enter the identity or weight of the product. Alternatively, each of the shelves may have been preselected for a particular product, and the server may already know the identity and weight of the product. In that case, the server will simply display a message to the store administrator to load a particular product, such as XYZ 8 oz. hot sauce onto the shelf. Once the products are selected for the shelf, the shelf is ready at step 1006.

FIG. 11 is a block diagram of an embodiment of a process 1100 for loading a shelf. At step 1102, an employee waves an employee RFID card or an employee NFC device in front of the shelf. Alternatively, the employee may be recognized using optical recognition techniques as described herein. At step 1104, the shelf instructs the employee through display 150, or on a screen of an NFC device, as to which items to load and the quantity of items to load onto the shelf. At step 1106, the employee completes the process and the shelf is ready for customers. In addition, camera 158 (FIG. 2B) can be used to scan codes on the products, including QR codes and similar codes. Alternatively, a bar code scanner 170 (FIG. 2B) can be used to scan bar codes on the products. In the process of loading a shelf, an employee may scan the bar code of a product at the shelf, which provides information to the store server, such as store server 102, as to which items are being stocked on the shelves 106-110, of FIG. 1.

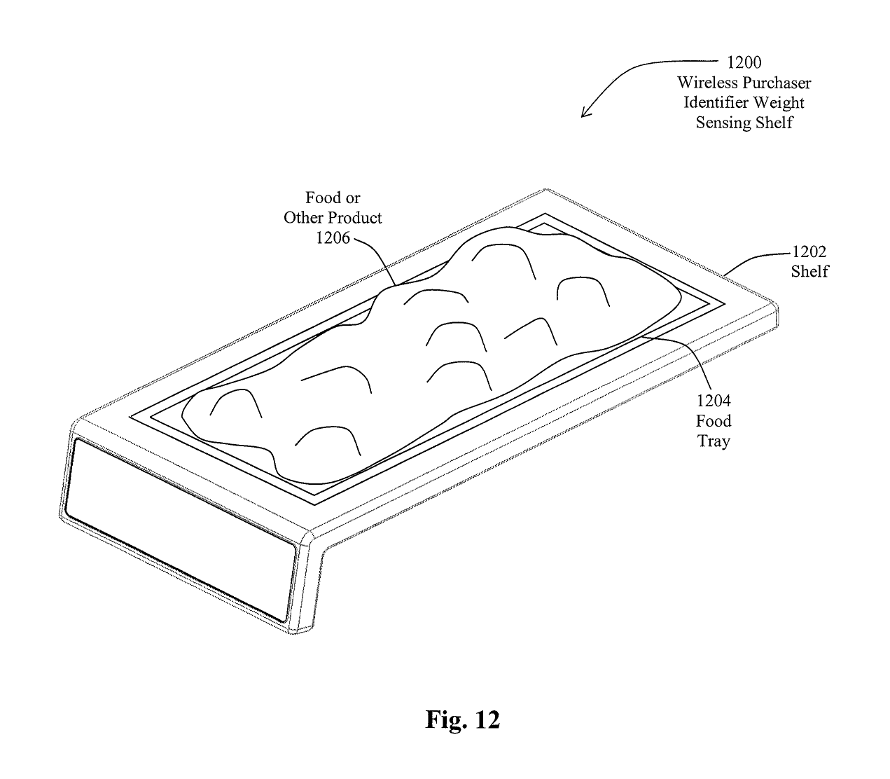

FIG. 12 is a schematic isometric view of another embodiment of a wireless purchaser identifier weight sensing shelf 1200. As illustrated in FIG. 12, weight sensing shelf 1200 is similar to the weight sensing shelf 104, illustrated in FIG. 2A. The weight sensing shelf 1200 has a middle portion removed to allow a food tray 1204 to be inserted in the remaining shelf frame 1202. Food tray 1204 contains a food 1206, which can be accessed by a purchaser. For example, food 1206 may be hot food in a food tray 1204 in a buffet line located in a restaurant or grocery store. A purchaser may spoon out the desired amount of food 1206 and place that amount on a plate or in a carryout container. Food 1206 may be a loose food, such as rice, mashed potatoes, or any desired type of food, that is displayed in food tray 1204. Shelf 1200 carefully measures the amount of food 1206 that is removed by the purchaser by measuring the weight of the food removed, and transmits that information to the store server, such as store server 102, illustrated in FIG. 1. In addition, the temperature sensors, such as temperature sensor 154 (FIG. 2B), on the weight sensing shelf 1200 can monitor and provide information to a store administrator and a purchaser regarding the temperature of the food 1206 in the food tray 1204.

Alternatively, other products 1206 can be stored in the tray 1204, illustrated in FIG. 12. For example, nails, bolts, deck screws, or other products can be placed in the tray 1204 for removal by a purchaser at a hardware store or lumber yard. Again, the purchaser waves a wireless identifier 129, 131 in front of the weight sensing shelf 1200, so that the purchaser is identified, or optical recognition techniques can be used. At that point, the purchaser may remove the product from the tray 1204. The weight sensing shelf 1200 then transmits the weight information to the store server, such as store server 102 of FIG. 1.

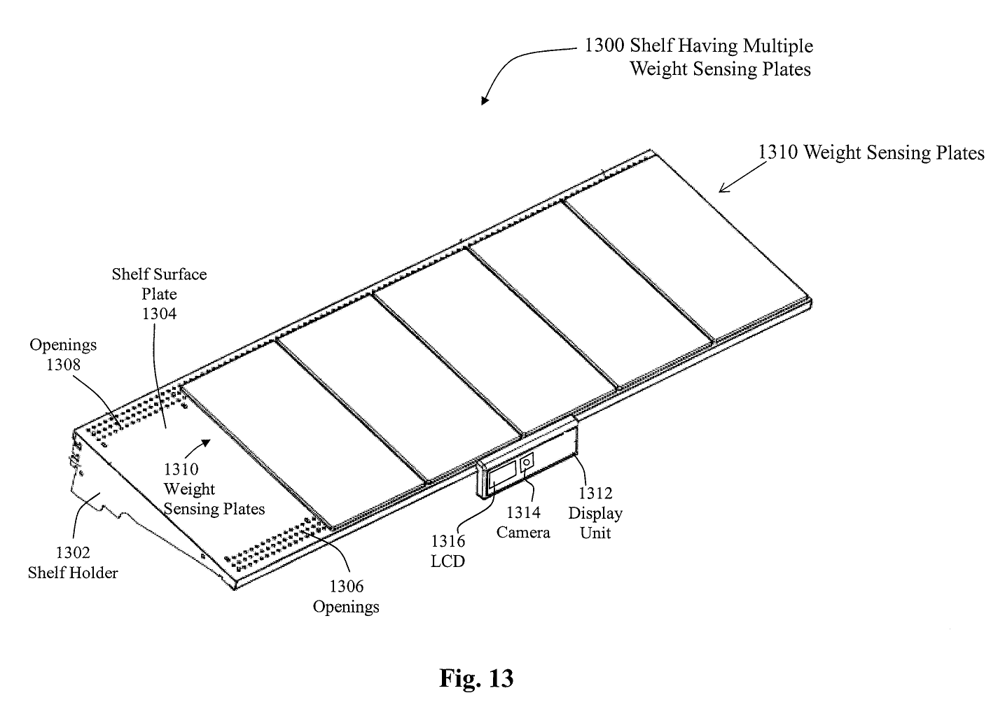

FIGS. 13-16 illustrate a shelving system having multiple shelves, such as shelf 1300 of FIG. 13, with each shelf having multiple weight sensing plates 1310. Each of the shelves, such as shelf 1300 of FIG. 13, is mounted on a shelf rack to display items for purchase.

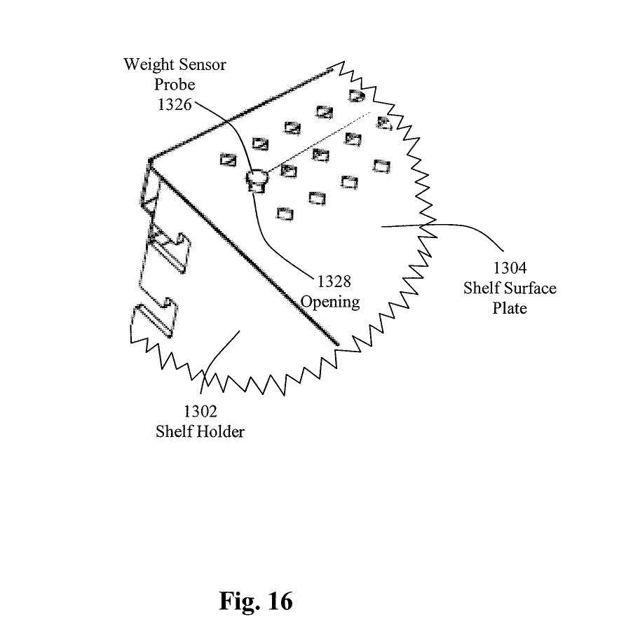

FIG. 13 is a schematic isometric diagram of an embodiment of a single weight sensing shelf that is part of the shelf rack of the shelving system. As illustrated in FIG. 13, shelf holder 1302 is attached to a shelf surface plate 1304. The shelf surface plate has a plurality of openings 1306, 1308 at peripheral end portions of the shelf surface plate 1304. A plurality of weight sensing plates 1310 are placed on the shelf surface plate 1304 and are supported by weight sensor probes 1326 (FIG. 16). A display unit 1312 is mounted on the front portion of the shelf surface plate 1304 and displays various information, as disclosed above. Display unit 1312 may be similar to the display unit illustrated in FIG. 2B, which includes a liquid crystal display 1316 and a camera 1314. The display may also include other items, such as a bar code reader, a motion sensor, a wireless transceiver, an NFC reader, an RFID reader and other devices described herein. A processor may also be included in the display unit 1312 to process the various data collected and to assist in the display of data on LCD 1316. Display unit 1312 is coupled to the weight sensing plates 1310 to display data relating to the weight sensing plates 1310, as described below.

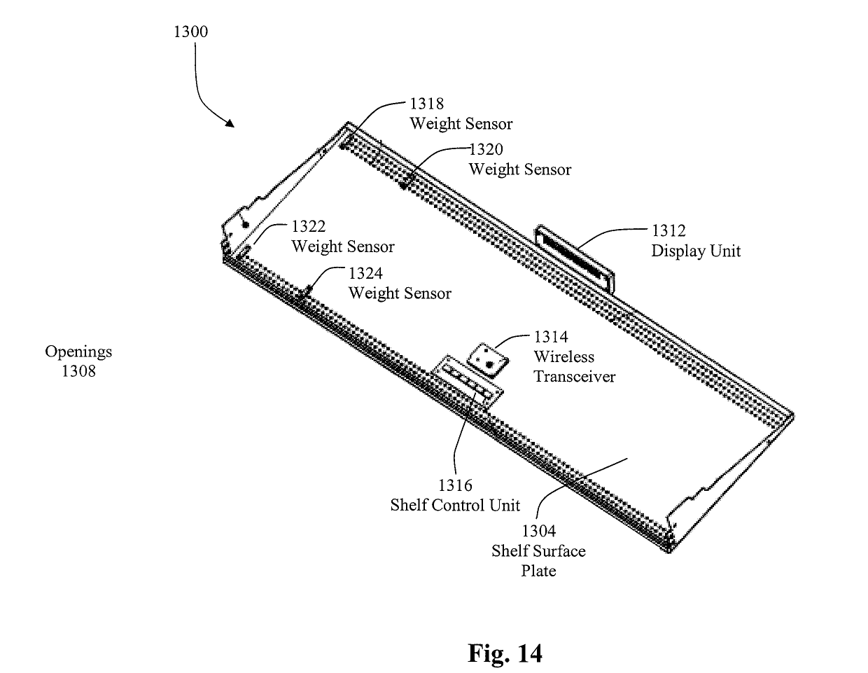

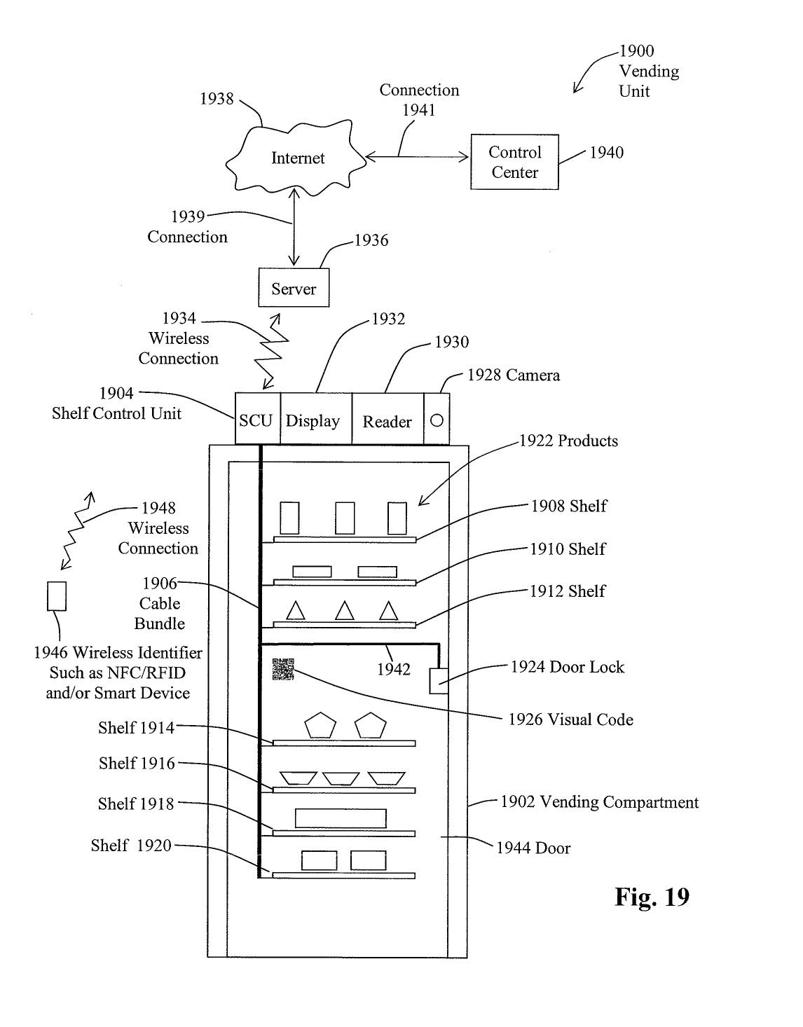

FIG. 14 is a schematic isometric bottom view of a shelf 1300 having multiple weight sensing plates. As illustrated in FIG. 14, a wireless transceiver 1314 may be mounted on the bottom surface of the shelf surface plate 1304, or in the display unit 1312. Wireless transceiver 1314 communicates with a store server, such as store server 102 (FIG. 1). A shelf control unit 1316 includes various components that may correspond to the shelf control unit 1904, illustrated in FIG. 19. Shelf control unit 1316 is connected to each of the weight sensing plates 1310. The shelf control unit may include connectors for connecting each of the weight sensing plates 1310 to allow the weight sensing plates 1310 to be easily replaced, or repaired, if needed. The shelf control unit 1316 may include a multiplexing circuit for reading the weights measured by each of the weight sensing plates 1310. The shelf control unit 1316 may be connected to a store server 102 using either a wireless connection or a wired connection. The store server 102 may be located so that a local wireless connection, that is protected by encryption, can be used to communicate with the shelf control unit 1316. In that regard, each of the shelves in a shelf rack includes a plurality of weight sensing plates 1310, so that multiple items can be sold on each shelf rack. By using a single display unit 1312 for each shelf, the complexity of programming and loading the items for sale on the weight sensing plates 1310 can be simplified.

As also illustrated in FIG. 14, a plurality of weight sensors 1318, 1320, 1322, 1324 are connected at any desired location on the bottom surface of the shelf surface plate 1304, depending upon the width of the weight sensing plates 1310. In other words, weight sensing plates can be specifically designed to be wider or narrower. The weight sensors 1318-1324 can be mounted in the openings 1306, 1308 at the locations corresponding to the selected width of the weight sensing plates 1310. The weight sensors 1318-1324 may comprise load cells that provide a very accurate measurement of weight. A simple mounting procedure is utilized, which allows a screw to be inserted through the middle opening of the openings 1306, 1308 and attached to a center portion of the weight sensors 1318, 1324.

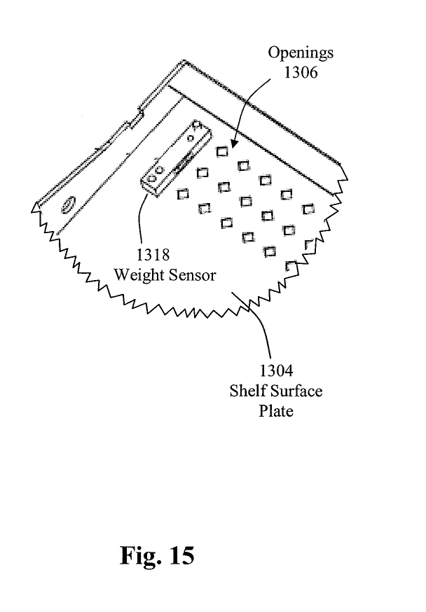

FIG. 15 is a close-up view of a weight sensor 1318 mounted in openings 1306. As illustrated in FIG. 15, weight sensor 1318 is easily mounted in the openings 1306 on the bottom portion of the multiple sensing shelves 1300. One or more screws may be inserted through one or more of the openings 1306 to secure the weight sensor 1318 to the bottom of the shelf surface plate 1304 in a simple and easy manner.

FIG. 16 is a close-up view of the top surface of a portion of the shelf surface plate 1304. As illustrated in FIG. 16, a weight sensor probe 1326 extends from the weight sensor 1322 and protrudes through opening 1328. The weight sensor probe 1326 rests against the weight sensor, which provides a weight reading of the weight resting on the probe 1326. The weight sensing plates 1310 rest directly on the weight sensing probe so that the weight of objects on the weight sensing plates can be measured. Accordingly, weight sensor probe 1326 and other similar weight sensing probes allow weight sensor 1322 and other similar weight sensors to detect the weight of products that are placed on, and removed from, the weight sensing plates 1310.

Hence, the automated purchasing system 100 disclosed herein allows users to simply enter a store, be identified using an RFID card, an NFC device, or by optical recognition techniques, remove products, and exit the store. The checkout process is eliminated, which eliminates large costs associated with all of the equipment and labor required for checkout. Information on selected items can be immediately transmitted to the purchasers for display on a smart communicator, such as a smart phone, a tablet computer, or similar device. In addition, problems with an account can also be identified early in the shopping process to eliminate these problems early in the process, and eliminate wasted time. The automated purchasing system identifies the user, identifies the products that were taken by the user, and automatically charges the user, so that the user can exit the store without the delayed process of checking out. In other embodiments, prepaid RFID cards can be used, or the user can simply pay cash at a kiosk or at a customer service counter. Again, RFID cards and NFC devices can be loaded with funds when the balance on the card or NFC device is low. Automatic refreshing of funds can also occur, as described above, so that an RFID card or NFC enabled device can continue to be used for purchasing product, as also described above. In these instances, the checkout process is also greatly simplified. Because of the short field for the wireless communication between an RFID and the wireless purchaser identifier weight sensing shelves 104, as well as the short distance required for near field communication devices, there can be little trouble with the shelf mistakenly identifying an incorrect purchaser. Also, optical recognition techniques can be implemented so that the purchaser is recognized at the shelf. Additionally, items can be returned to the shelf by simply placing the RFID card, NFC device near the shelf to identify the user, or optically identifying the user, and simply replacing the item on the shelf. The automated purchasing system 100 is simple and easy to use, utilizes currently existing technologies, such as NFC technology, RFID cards, and optical recognition techniques, and greatly reduces costs associated with the retail sales of goods.

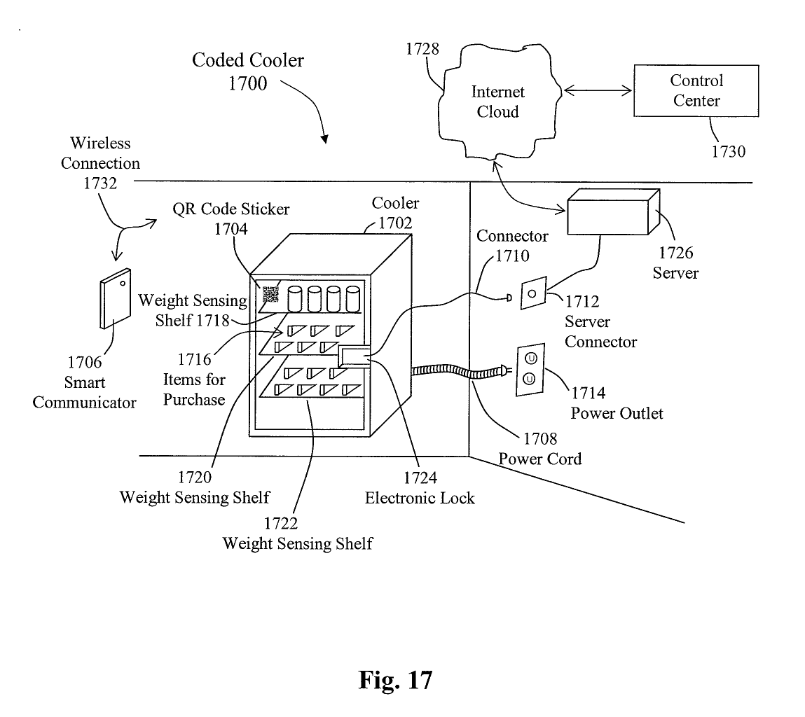

FIG. 17 is a schematic illustration of a coded cooler system 1700. The system includes a cooler 1702 or other compartment that can be opened by a user. Although the embodiment illustrated in FIG. 17 shows a cooler 1702, any type of enclosed compartment can be utilized to access items for purchase 1716 by unlocking a compartment. For example, the cooler may be a locked compartment that contains non-food items for sale. For purposes of illustration, the embodiment disclosed in FIG. 17 is described as a cooler, with the understanding that the same principles apply to any type of locked compartment that contains items to be dispensed or purchased.

Cooler 1702 includes a QR code sticker 1704. Of course, any type of graphic code can be used other than QR code. The QR code is simply used as an example of a graphic code that can be utilized as one example of a graphic code. Cooler 1702 has a plurality of weight sensing shelves 1718, 1720, 1722, such as described above, that have very accurate weight sensors for measuring the weight of products placed on the shelves, as disclosed above. In addition, the weight sensing shelves 1718-1722 may contain processors, such as described above, that can identify each of the items either placed on, or removed from, the shelves from information stored in association with the processor that includes the weight of the items. Alternatively, the weight and identity of the item may be stored in server 1726, Internet cloud 1728, or control center 1730. The identity of the product can be determined by any of these devices using a list of products and weights. Each of the weight sensing shelves 1718-1722 are connected to the server 1726, either by a wireless connection or through a server connection, such as server connection 1712, so that information relating to the products removed from the weight sensing shelves 1718-1722 is transmitted to the control center 1730, or derived by the control center 1730 from weight data. Cooler 1702 also includes an electronic lock that may operate in any standard fashion, such as by electromagnetic actuation. The electronic lock 1724 is connected to a connector 1710 that is, in turn, connected to a server connection 1712. Server 1726 is operatively coupled to the server connection 1712. Server 1726 is connected to the Internet 1728, which, in turn, is connected to the control center 1730. A wireless connection can also be used between cooler 1702 and server 1726. Control center 1730 operates electronic lock 1724 in response to signals from smart phone 1706 over wireless connection 1732. Cooler 1702 also has a power plug 1708, which is connected to a power outlet 1714. It should also be noted that the electronic lock 1724 can also be operated by coded information that is wirelessly transmitted, or coded information that is transmitted through the power cord 1708 and power outlet 1714, so that connector 1710 and server connector 1712 can be eliminated.

In operation, a smart communicator 1706, such as a smart phone, tablet computer, or other device that is capable of processing information, is used to scan the QR code sticker 1704 on cooler 1702. Initially, the smart communicator 1706 may access a website in response to the scanned QR code to download an application. Alternatively, the application may be downloaded from another processing device, over the Internet, such as from an application store, to the smart communicator 1706. The user must sign up for the service and provide a billing account, such as a credit card account, bank account, or other account, which can be charged by the control center 1730. Once the application is loaded in the smart communicator 1706, the smart communicator 1706 scans the QR code sticker 1704, which processes the information from the QR code. The QR code sticker 1704 contains information relating to the identification of the cooler 1702, which is generally referred to as a compartment identification code. The software application in the smart communicator 1706 then transmits the compartment identification code, together with the user identification code, and/or a password/username and password, to control center 1730. Typically, this communication is performed wirelessly over wireless connection 1732. Alternatively, the communication may be transmitted through a hardwired connection. The wireless connection 1732 may be a WiFi connection, mobile communication link, a cellular data connection, or other wireless connection, which accesses the control center 1730 via Internet 1728. The control center receives the user identification code and/or a password/username and password (collectively referred to as a user id code), as well as the compartment identification code, and compares the user identification code and associated compartment identification code with a list of authorized user identification codes and compartment identification codes. If the user id code is recognized by the control center, the control center 1730 generates an unlock code, which is transmitted through Internet 1728 to server 1726 to server connection 1712 and connector 1710 to unlock the electronic lock 1724. These functions can also be performed on the Internet cloud 1728 or server 1726. The user of the smart communicator 1706 then has access to the cooler 1702. The user then removes items for purchase 1716 from the cooler 1702. Weight shelves 1718-1722 measure the weight of the items removed and identify these items by their weight. The weight sensing shelves 1718-1722 then transmit a product identification code either wirelessly, or through connector 1710, server connection 1712, server 1726, Internet 1728, to control center 1730, which charges the billing account associated with the user id code for those products. Again, these functions can also be performed by server 1726 and Internet cloud 1728. When the cooler 1702 is shut, electronic lock 1724 automatically locks the cooler 1702. Alternatively, a switch located on the cooler 1702 can signal the server 1726, indicating that the cooler 1702 is closed. Server 1726 can then generate a signal to activate the electronic lock 1724 to lock the cooler 1702.

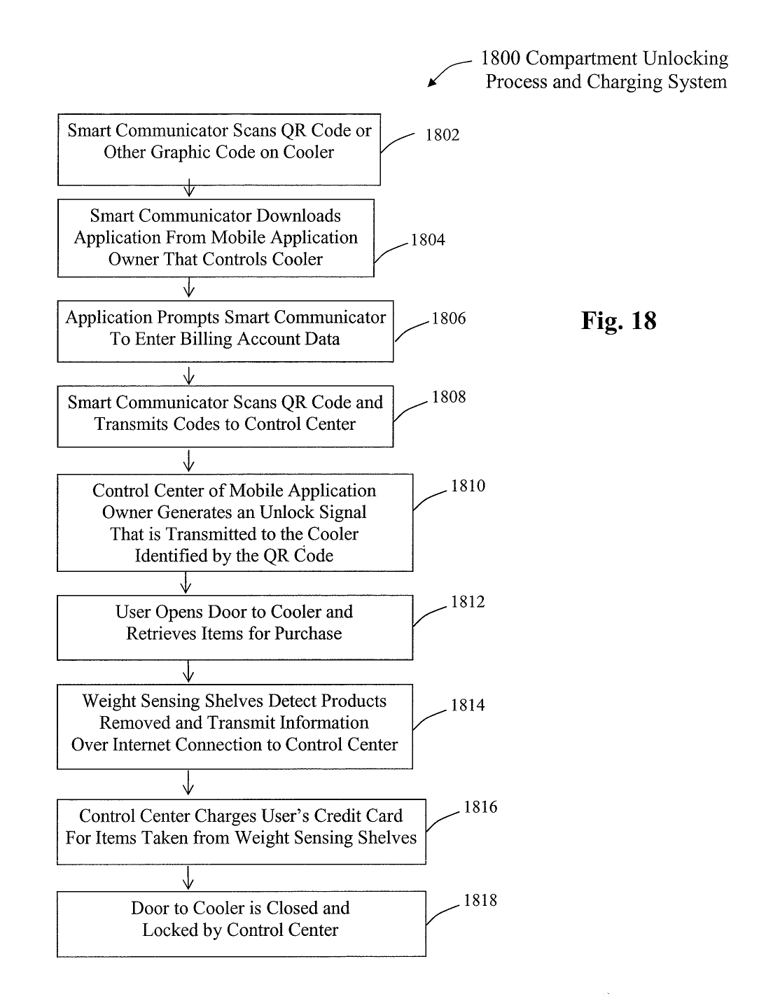

FIG. 18 is a flow diagram illustrating an embodiment of a compartment unlocking process and charging system 1800. As shown in FIG. 18, the smart communicator 1706 scans a QR code, or other graphic code, on the cooler. At step 1804, the smart communicator 1706 is directed to a website from the graphic code and downloads a software application from a mobile application owner that controls cooler 1702, or other locked compartment. At step 1806, the software application prompts the smart communicator 1706 to enter billing account data, or other account data. Alternatively, the smart communicator 1706 can download the application from another computer system. At step 1808, the smart communicator 1706 scans a QR code 1704 and transmits codes to the control center 1730. Again, these codes may comprise a compartment identification code for the cooler 1702, as well as a user identification code. At step 1810, the control center 1730 for the mobile application owner generates an unlock signal if there is a match for the user identification code in an authorized list of user identification codes. In some instances, certain compartments will be available to certain users, so that a match must exist for both the user identification code and the compartment identification code in a list of authorized codes stored by the control center 1730. At step 1812, the cooler 1702 is unlocked in response to the unlock code transmitted by the control center 1730, and the user opens the door to the cooler 1702 and retrieves the items for purchase. At step 1814, the weight sensing shelves 1718-1722 detect the products removed and transmit product identification codes and/or weight information through the Internet 1728 to the control center 1730. At step 1816, the control center charges the user's billing account, such as a credit, debit, bank account, or other billing account, for the items taken from the weight sensing shelves, as determined by weight information and product information. At step 1818, the door to the cooler is closed and locked by the control center.

FIG. 19 is a schematic block diagram of a vending system 1900 that is similar to the system of FIG. 17. In accordance with FIG. 19, items are vended through a vending compartment 1902, rather than specifically a cooler, as disclosed with respect to FIG. 17. The vending compartment 1902 can be a cooler, freezer, or simply a locked compartment that has items available to be sold to a purchaser. Any retail item or product 1922 can be placed in the vending compartment 1902 for sale. The products 1922 are located on shelves 1920, 1922, 1924, 1926, which, in general, can comprise any number of shelf units. Shelves 1920-1926 may comprise any of the embodiments of shelves disclosed herein and similar shelves that are capable of measuring the weight of the products to determine if one or more products have been removed from or replaced on the shelves 1920-1926.

As illustrated in FIG. 19, shelf control unit 1904 is connected to each of the shelves 1908-1920 through a cable bundle 1906. The shelf control unit 1904 may include connectors for connecting each of the shelves 1908-1920 to the shelf control unit 1904. In this manner, the shelf control unit 1904 can be easily removed and replaced, or repaired, if needed. In addition, the cable bundle 1906 can be connected to the shelves 1908-1920 using connectors that allow the shelves to be easily replaced, or repaired, if needed. Shelf control unit 1904 may include a multiplexing circuit for reading the weights measured by each of the shelves 1920-1926. The shelf control unit 1904 is connected to the server 1936 through a wireless connection 1934. The server 1936 may be a simple server and the wireless connection 1934 may be a local wireless connection that is protected by encryption. Wired connectors can also be used. Server 1904 is connected to the Internet 1938 using any convenient connection, i.e., either wired or wireless. Data regarding the weight of products 1922 from each of the shelves 1908-1920 may be stored at the control center 1940 and transmitted back to the server 1936 through Internet 1938, or a private network. Control center 1940 communicates through Internet 1938 or a private network and provides the data regarding the identity of products, the weight of the products, the programming of the shelves, etc. The server 1936 provides the data which is transmitted back to the shelf control unit 1904 and transferred to the display 1932, which displays the identity of the item that has been removed from a shelf, and the number of items that have been removed. If one or more items have been replaced on the shelf, and have the proper weight, the display 1932 may also display information relating to the items replaced. Reader 1930 is capable of reading an NFC device, such as an NFC device that may be included in a phone, or other smart communicator, or an RFID card. These devices identify the user, so that a user's account can be charged in the manner described above with respect to the description of FIG. 1.

The vending compartment 1902, of FIG. 19, may have a camera 1928 located on the device. Camera 1928 can be used for various purposes. For example, the camera 1928 can be used to keep a record of the use of the vending unit 1900. In addition, camera 1928 can be used for recognition and identification purposes. For example, the vending unit 1900 may be used in conjunction with a recognition system, such as a pattern recognition system. Various pattern recognition systems are readily available. For example, optical facial recognition may be a viable technique for identifying a user. In a situation where there are a limited number of users, such as in a business or in a local store that has members that have a membership for use of the vending unit 1900, facial recognition can be performed with a high degree of accuracy, since pictures can be taken of members faces in a controlled environment and there are a finite number of members in the system. For example, a local store may have less than a thousand individuals that are members of the store that have access to the vending units 1900. These members can have pictures taken under controlled circumstances that would allow for application of very accurate facial recognition techniques. Alternatively, a user may wear an optically coded device, such as an optically coded sticker, a pin, card, or other optically coded device, that provides identification of the user to the recognition system. Camera 1928 can optically identify a sticker, pin, card, or other optically coded device, within a certain range of the camera 1928, to provide access to the vending unit 1900. Upon obtaining identification data, either by camera 1928 or by the reader 1930, the purchaser can be identified by processing techniques that can be performed in either the shelf control unit 1904, the server 1936, or the control center 1940. If there is a positive recognition, an unlock signal is generated, which is transmitted through connector 1942 to door lock 1924 to unlock the door 1944. The optically coded device may comprise a sticker or pin or other device, such as a card or other device that can be shown to the camera, and which can be recognized using optical pattern recognition techniques. Of course, any type of device can be used for the purpose of recognition, including stickers, pins, cards, or other optically coded devices that can be placed on clothing or other locations on the user, or shown by the user to the camera.

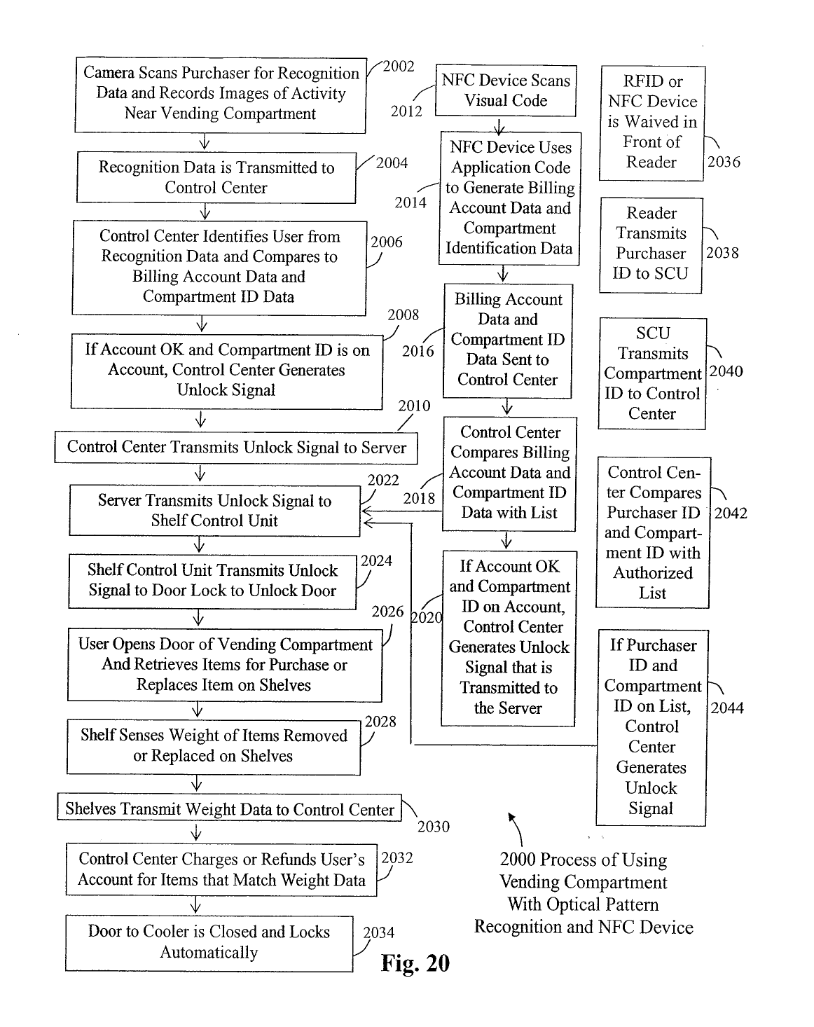

As also illustrated in FIG. 19, visual code 1926 can also be placed on the vending compartment 1902, which can be scanned by a smart communicator, such as a smart phone, table computer, or similar device. Visual code 1926 may comprise a bar code, a QR code, or similar visual code, that is scanned by smart communicator 1946. Smart communicator 1946 then communicates with the server 1936, which in turn communicates with the control center 1940. Again, the visual code 1926 contains information relating to the identification of the vending compartment 1902, which can be referred to as the vending compartment identification code. A software application downloaded into the smart communicator 1946 transmits the vending compartment identification code, together with the smart phone identification code for the smart communicator, and a password/username to the control center 1940. Typically this communication is performed over the wireless connection 1948 between the smart communicator 1946 and the server 1936. The Internet 1938 or a private network receives the NFC device identification code and a user ID code that includes a password and username, as well as the compartment identification code, and transmits this information to control center 1940. Control center 1940 compares the user identification code and the associated compartment identification code with a list of authorized user identification codes and compartment identification codes. If there is a match, the control center 1940 generates an unlock signal that is transmitted to server 1936 via Internet 1938. The server 1936 transmits the unlock signal over wireless connection 1934 to the shelf control unit 1904 that transmits the unlock signal on connector 1942 to unlock the door lock 1924. This is explained in more detail with respect to FIG. 20.

FIG. 20 is a process 2000 for using the vending compartment 1900. At step 2002, the process for using optical pattern recognition is initiated. At step 2002, the camera scans a purchaser for recognition data. The recognition data can be facial recognition, or other feature recognition of the user, including retinal scan or iris scan, or scanning of an optical recognition device, such as a sticker, lapel pin, card, or other optically encoded device worn or displayed by the user. In addition, camera 1928 also records images of activity near the vending compartment to ensure that there is no fraudulent activity. At step 2004, the recognition data is transmitted to the control center 1940 from the camera 1928, to the shelf control unit 1904, to the server 1936 by the wireless connection 1934, to the Internet 1938, and the control center 1730, via connections 1939, 1941. Wireless connection 1934 can also be a wired connection. However, it may be more convenient in many cases to have a wireless connection, such as connection 1934. At step 2006, the control center 1940 identifies the purchaser from recognition data and compares the recognition data to the billing account data and the compartment identification data. In that regard, the control center 1940 uses processing techniques to perform recognition of the recognition data to identify the purchaser, and then compares the identification of the user to the billing account data to determine if the user has an account. The account is also reviewed to determine if the account is in good standing. The compartment identification data that is transmitted to the cloud 1938 is also compared with compartment identification data that can be accessed by the user's billing account. If the user is authorized to access the vending compartment 1902, as a result of determining if the purchaser's billing account data provides access to the vending compartment 1902, the process proceeds to step 2008 and the cloud generates an unlock signal.

Alternatively, as also illustrated in FIG. 20, a near field communication device, such as an NFC smart communicator, scans the visual code 1926 that can be located on door 1944 of the vending compartment 1902. At step 2014, the near field communication device, which can be a smart phone, a tablet computer, or other NFC device, uses the application code that has been downloaded to the NFC device from a website to generate billing account data and compartment identification data that identifies the vending compartment 1902. At step 2016, the billing account data and the compartment identification data are sent to the control center 1940 via server 1936 and shelf control unit 1904. The processing, that is performed in the control center 1940, compares the billing account data and the compartment identification data with a list of authorized billing accounts and compartment IDs at step 2018. At step 2020, if the account is okay, and the compartment identification is an authorized compartment for the account, the control center 1940 generates an unlock signal that is transmitted to the server 1936 and the process proceeds to step 2022. Alternatively, an NFC device, or an RFID device, can be waived in front of the reader 1930 to identify the purchaser.

Alternatively, an RFID device, or an NFC device that may not comprise a smart communicator, can be waived in front of the reader 1930, at step 2036. At step 2038, the reader 1930 transmits the purchaser ID, as read from the RFID device, or NFC device, to the shelf control unit 1904. At step 2040, the shelf control unit transmits the compartment identification data and the purchaser identification data to the control center 1940. At step 2042, the control center 1940 compares the purchaser ID and the compartment ID with an authorized list of users of the compartment. The control center also determines the balance on the RFID card, or the balance on an account associated with the RFID card. If the purchaser ID and the compartment ID favorably compare with the authorized list, and there is a sufficient balance on the RFID card, or NFC device, the control center generates an unlock signal at step 2044. The process then proceeds to step 2022. Of course, the RFID identification, or NFC identification, can be recognized at either the server 1936, or control center 1940. In addition, the association of the RFID card ID, or NFC ID, with a purchaser ID, and account information can also occur at either the server 1936, or control center 1940. In that regard, server 1936 can also identify the balance of funds on the RFID card or NFC device, as well as a control center 1940.

At step 2022, of FIG. 20, the server 1936 transmits the unlock signal to the shelf control unit 1904. The shelf control unit 1904 transmits the unlock signal to the door lock 1924 to unlock the door 1944 of the vending compartment 1902. At step 2026, the user can then open the door to the vending compartment and retrieve items for purchase and/or replace items on the shelves 1908-1920. At step 2028, the shelves 1908-1920 sense the weight of items that have either been removed or replaced on the shelves 1908-1920. The shelves themselves can be programmed to sense the weight and identify the goods that have been removed or replaced. Otherwise, that function can be performed in the shelf control unit 1904, the server 1936, or the control center 1940. In any event, the identification of the products and the amount of products replaced or removed, or the weight, can be sent to the various stages, such as the shelf control unit, server 1936, or cloud 1938, so that the purchaser's account can be charged. In the case where the control center 1940 identifies the products and the amount of the products that are removed or replaced from the shelves 1908-1920, the weight data can be transmitted to the control center 1940, as illustrated at step 2030. At step 2032, the control center 1940 then charges or refunds the purchaser's account for the items that match the weight data. At step 2034, the door to the cooler is closed and locks automatically.

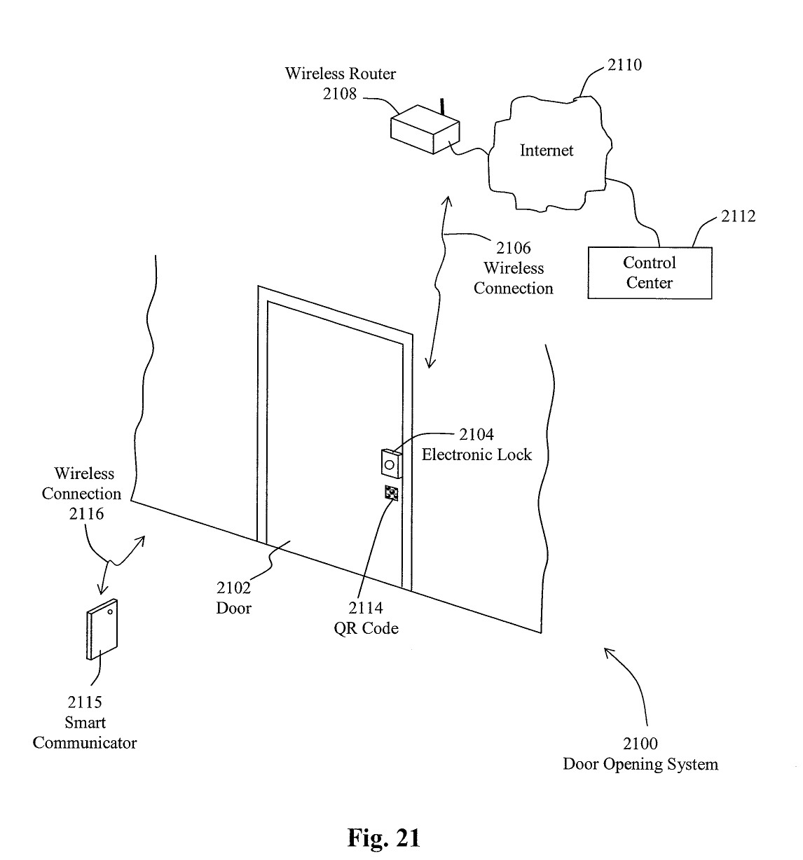

FIG. 21 is a schematic illustration of another embodiment illustrating a door opening system 2100. Although FIG. 21 illustrates an automated method for opening a door, any type of access port can be opened using the process illustrated in the embodiment of FIG. 21. For example, any type of door can be opened, including house doors, office doors, doors to safes, store room doors, supply room doors, or any other type of portal.

As illustrated in FIG. 21, door 2102 includes an electronic lock 2104 that generates a magnetic field to operate the electronic lock 2104. Disposed on, or proximate to, the door 2102 is a QR code 2114 or any type of graphic code that can be scanned by a smart communicator 2115, such as a smart phone. The electronic lock 2104 may include a hardwired connection to a wireless router 2108 or other router via wireless connection 2106, or a hardwired connection to wireless router 2108. Wireless router 2108 is connected to Internet 2110. Control center 2112 is also connected to the Internet 2110. Smart phone 2114 also has a wireless connection 2116. The wireless connection may be through a wireless router 2108, or other wireless router, or over a WiFi connection, a mobile communication link, or other connection to Internet 2110.

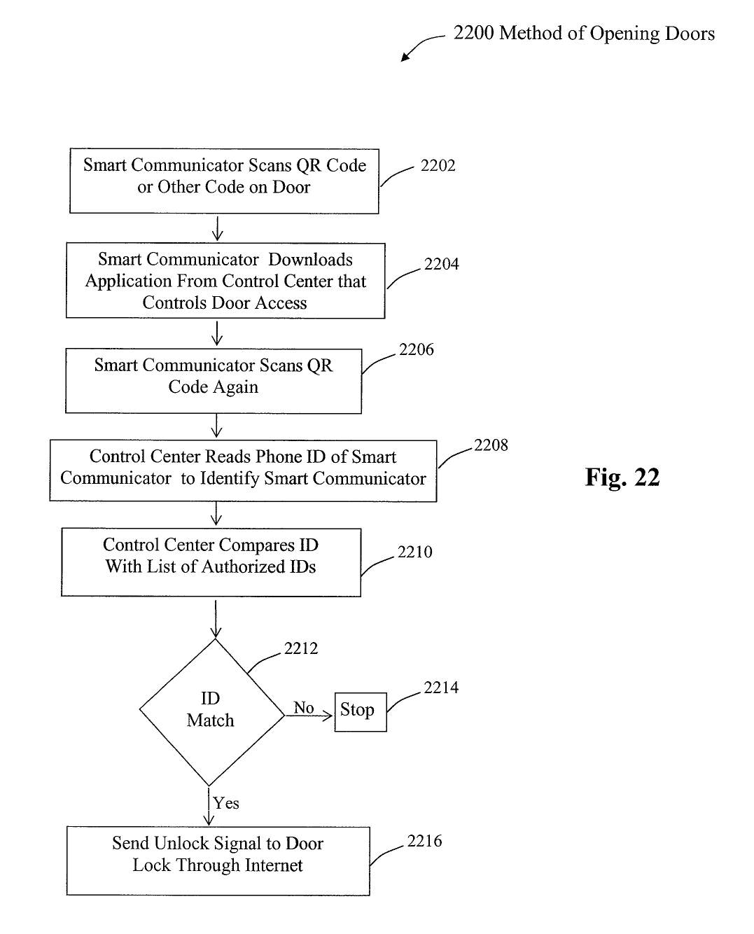

FIG. 22 is a flow diagram 2200 illustrating the method of the operation for opening doors and other access portals, such as the system illustrated in FIG. 21. As illustrated in FIG. 22, at step 2202, the smart communicator 2115, or other smart communicator, scans the QR code, or other graphic code, that is placed on or near the door 2102. The smart communicator 2115 downloads a software application from a control center 2112. The smart communicator 2115 may have already downloaded the software program, either wirelessly by accessing a website to which the smart communicator 2115 was directed by the QR code, or downloaded the software from another computer system. In any event, the smart communicator 2115 downloads the application at step 2204, which controls access to the electronic lock 2104. At step 2206, the smart communicator 2115 scans the QR code 2114 to connect directly to the control center 2112 via wireless connection 2116. The smart communicator 2115 transmits a user identification code, which identifies the smart communicator 2115 and/or user, as well as a graphic code identification number corresponding to the particular QR code 2114 located on or near door 2102. The control center 2112 then compares the user id code and the port access code, corresponding to the QR code 2114, with a list of authorized user identification codes and access port identification codes, at step 2210. At step 2212, if there is not a match, the process is stopped at step 2214, and the door 2102 will not be opened. If there is a match, the control center 2112 sends an unlock code to the electronic lock through Internet 2110, wireless router 2108 and wireless connection 2106. The door 2102 is then unlocked, so the user of the smart communicator 2115 can enter the door 2102.

FIG. 23 is an isometric view of an embodiment of a weight measuring hanger 2300. As disclosed in FIG. 23, the weight measuring hanger 2300 includes a hanger rod 2302 having a raised end 2304. The hanger rod 2302 allows product to be held and displayed in accordance with standard retail displays of products in a retail store. Raised end 2304 prevents the product from sliding off of the end of the hanger rod 2302. The hanger rod 2302 is supported in a bracket 2308 that has hooks 2310, 2312. Hooks 2310, 2312 attach to standard retail display mounting devices disposed on a display wall for displaying products. Cover 2306 covers the load cells that measure the weight of the products that are hanging from the hanger rod 2302 and provide an electrical weight measurement signal that is capable of identifying the weight, and hence the number of products that have been removed from, or placed on, the hanger rod 2302.

Hangers for displaying products are widely used in many retail stores. Various products can be displayed using hanger displays, such as food products that are sealed in airtight plastic containers that may have a perforation that engages a hanger rod, or any type of retail product that has an integral hook that can engage a hanger rod. Hanger displays are effective ways of displaying retail products, so that users can readily access the products by removing the products from the hanger while providing the products in a manner in which they are readily visible to purchasers. The weight measuring hanger 2300, illustrated in FIG. 23, provides all of the advantages of a retail hanger display, but is also capable of providing weight measurements that indicate the number of products that have been removed from, or placed on, the hanger rod 2302.

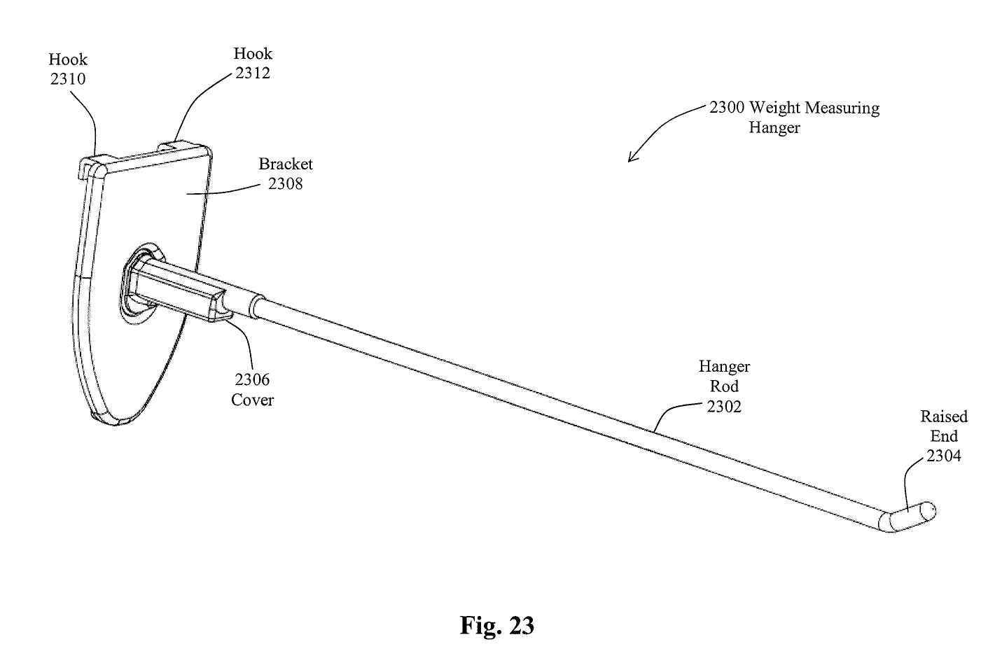

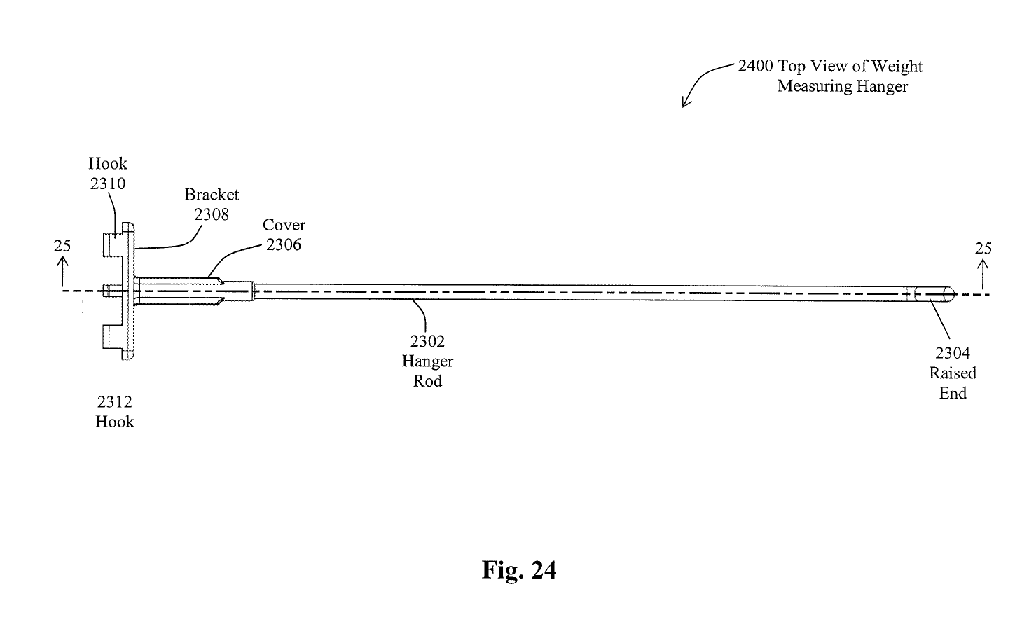

FIG. 24 is a top view of the weight measuring hanger 2400 of the weight measuring hanger 2300, illustrated in FIG. 23. As shown in FIG. 24, the hanger rod 2302 includes a raised portion 2304. The hanger rod 2302 is coupled to the bracket 2308 that supports the hanger rod 2302. The bracket 2308 has hooks 2310, 2312 that engage mounting brackets that are normally disposed on a vertical wall in a display area in a retail store.

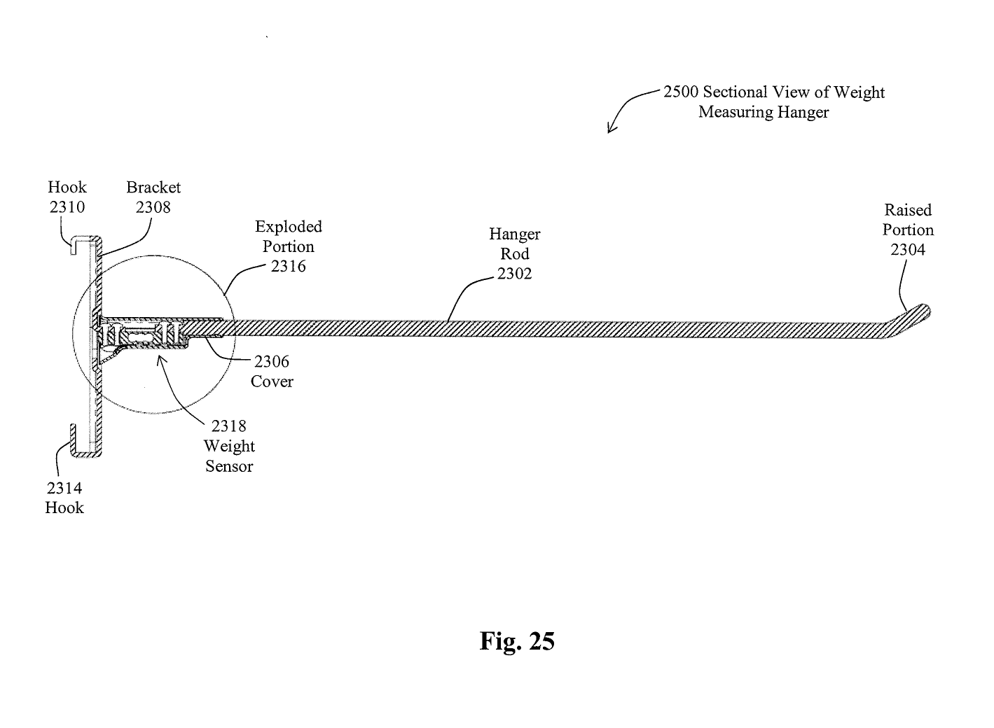

FIG. 25 is a sectional view 2500 of the weight measuring hanger 2300, illustrated in FIG. 23. The section illustrated in FIG. 25 is indicated in FIG. 24. As shown in FIG. 25, the hanger rod 2302, having raised portion 2304, is coupled to the bracket 2308 by way of a weight sensor 2318. Weight sensor 2318 indicates the weight of the hanger rod 2302 and items that are hanging from the hanger rod 2302. Cover 2306 provides a protective cover to protect the weight sensor 2318. Bracket 2308 has a top hook 2310 and a bottom hook 2314 that engage a mounting bracket disposed on a substantially vertical surface. In addition, FIG. 25 illustrates the exploded portion 2316 that is shown in FIG. 27.

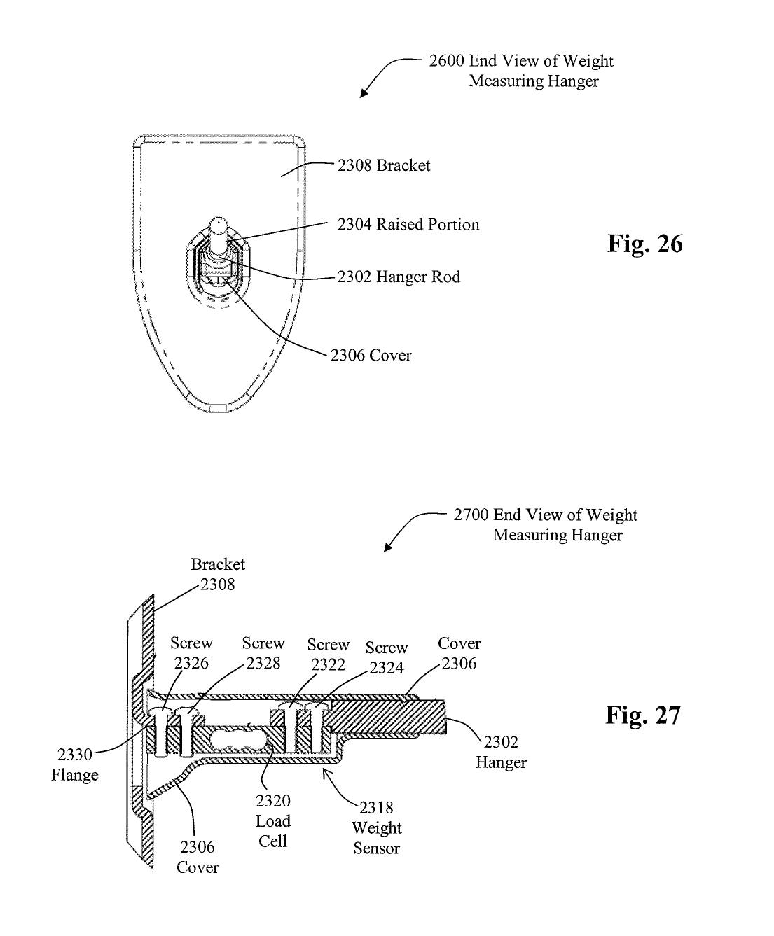

FIG. 26 is an end view 2600 of the weight measuring hanger 2300, illustrated in FIG. 23. As shown in FIG. 26, hanger rod 2302 has a raised portion 2304 that is coupled to the bracket 2308. Cover 2306 surrounds a portion of the hanger rod 2302 adjacent the bracket 2308.

FIG. 27 is a sectional view 2700 illustrating the weight sensor 2318. As shown in FIG. 27, the weight sensor includes a load cell 2320. The load cell 2320 is coupled by screws 2326, 2328 to the bracket 2308, and to the hanger rod 2302 by way of screws 2322, 2324. Cover 2306 is attached to the bracket 2308 and to the hanger rod 2302 to provide a protective covering for the weight sensor 2318. Flange 2330, which forms a part of the bracket 2308, provides an attachment surface for attaching the load cell 2320 to the bracket 2308. The load cell 2320 may comprise any desired type of load cell for measuring the weight of products placed on the hanger rod 2302. Simple bending load cells using any desired type of strain gauges can be used to measure the strain generated by the products that are placed on the hanger rod 2302.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of purchasing a product from a store using an automated purchasing system comprising:
using a weight sensing shelf to display said product, said weight sensing shelf having a wireless identification reader that reads a wireless identifier that is associated with a purchaser;
using said wireless identification reader to identify said purchaser when said purchaser places said wireless identifier proximate to said wireless identification reader;
using weight sensors in said weight sensing shelf to generate a weight signal that indicates an amount of said product removed from said weight sensing shelf;
transmitting said weight signal, that indicates said amount of said product removed from said weight sensing shelf, to a processor;
identifying said product and said amount of said product removed from said weight sensing shelf to charge said purchaser for said product removed from said weight sensing shelf.

2. The method of claim 1 further comprising:
placing said amount of said product and an identification of said product in a tabulated list of products associated with said purchaser.

3. The method of claim 2 further comprising:
paying for said tabulated list of products associated with said purchaser by automatically charging an account associated with said purchaser.

4. The method of claim 1 further comprising:
charging said purchaser for said product removed from said weight sensing shelf by deducting funds from a balance of funds carried on said wireless identifier.

5. The method of claim 3 wherein said account is a credit account.

6. The method of claim 3 wherein said account is a debit account.

7. The method of claim 3 wherein said account is a bank account.

8. The method of claim 2 further comprising:
transmitting said amount of said product and said identification of said product to a control center;
using said control center to charge said account associated with said purchaser for said tabulated list of products.

9. The method of claim 8 further comprising:
transmitting said tabulated list from said purchasing control system to said purchaser so that said purchase can monitor said tabulated list of products selected by said purchaser.

10. The method of claim 2 further comprising:
using a kiosk to display said tabulated list.

11. The method of claim 9 further comprising:
using said kiosk to pay for products on said tabulated list.

12. The method of claim 4 wherein said wireless identifier comprises an RFID card.

13. The method of claim 4 wherein said wireless identifier comprises an NFC device.

14. An automated purchasing system that allows purchasers to select and automatically purchase products from a store comprising:
a plurality of weight sensing shelves located in said store that display said products for sale;
weight sensors disposed in said weight sensing shelves that generate weight information relating to said products;
wireless identifiers that identify said purchasers;
wireless identification readers disposed in said weight sensing shelves that read said wireless identifiers placed proximate to said wireless identification readers and generate identification information relating to said purchasers;
a processor that receives said weight information and said identification information and charges said purchaser for products removed from said weight sensing shelves based upon said weight information.

15. The automated purchasing system of claim 14 wherein said processor tabulates a list of said products selected by said purchasers based upon said identification information and said weight information

16. The automated purchasing system of claim 14 further comprising:
wireless transmitters disposed in said plurality of weight sensing shelves that transmit said identification information and said weight information.

17. The automated purchasing system of claim 15 further comprising:
a control center that receives said tabulated list of products and assists said purchasers in paying for said tabulated list of products.

18. The automated purchasing system of claim 17 further comprising:
a kiosk in communication with said control center that displays said tabulated list of products and provides said purchasers with options for payment.

19. The automated purchasing system of claim 18 wherein said kiosk allows said purchaser to automatically pay for said tabulated list of products by charging an account.

20. The automated purchasing system of claim 18 wherein said kiosk allows said purchaser to pay cash.

21. The automated purchasing system of claim 14 wherein said wireless identifiers comprise RFID cards.

22. The automated purchasing system of claim 21 wherein said wireless identifiers comprise prepaid RFID cards.

23. The automated purchasing system of claim 14 wherein said wireless identifiers comprise near field communication (NFC) devices.

24. The automated purchasing system of claim 23 wherein said NFC devices comprise smart phones.

25. The automated purchasing system of claim 23 wherein said NFC devices comprise tablet computers.

26. The automated purchasing system of claim 14 wherein said processor further comprises:
a processor that uses said weight information to determine the amount of said products that have been placed on and removed from said weight sensing shelves.

27. The automated purchasing system of claim 26 wherein said processor is disposed in said weight sensing shelves and comprises a controller.

28. The automated purchasing system of claim 26 wherein said processor is disposed in a server which calculates the amount of products that have been placed on or removed from said shelves.

29. A method of purchasing products from a locked compartment using an automated purchasing system comprising:
scanning a graphic code on a compartment with a smart communicator;
processing said graphic code in said smart communicator using a software application downloaded by said smart communicator to generate a compartment identification code;
transmitting said compartment identification code and a user identification code from said smart communicator to a processor;
transmitting an unlock code from said processor to said compartment to unlock said compartment;
measuring the weight of said products removed from weight shelves in said compartment;
identifying said products removed from said weight shelves based upon said weight of said products to generate product identification information;
transmitting said product identification information that identifies said products removed from said weight shelves to said processor;
charging an account associated with said user identification code for said products removed from said weight shelves.

30. The method of claim 29 wherein said graphic code is a QR code.

31. The method of claim 30 wherein said products are food products.

32. The method of claim 31 wherein said smart communicator is a smart phone.

33. The method of claim 31 wherein said smart communicator is a tablet computer.

34. The method of claim 32 wherein said compartment is a cooler.

35. The method of claim 25 wherein said compartment contains non-food items for sale.

36. The method of claim 29 wherein said processor is located in a control center.

37. The method of claim 29 wherein said processor is located in a server.

38. The method of claim 29 wherein said processor is located in said weight sensing shelves.

39. A method of unlocking an access port using an automated control system comprising:
scanning a graphic code disposed proximate to said access port with a smart communicator;
processing said graphic code in said smart communicator using a software application to generate a portal identification code;
transmitting said portal identification code and a user identification code from said smart communicator to a control center;
comparing said portal identification code and said user identification code with a list of authorized portal identification codes and authorized user identification codes;
transmitting an unlock code to said portal if said portal identification code and said user identification code match an authorized portal identification code and an authorized user identification code.

40. The method of claim 39 wherein said smart communicator comprises a smart phone.

41. The method of claim 39 wherein said smart communicator comprises a tablet computer.

42. The method of claim 40 wherein said access port comprises a door to an office.

43. The method of claim 40 wherein said access port comprises a door to a house.

44. The method of claim 40 wherein said access port comprises a door to a safe.

45. The method of claim 41 wherein said access port comprises a hotel door.

46. The method of claim 34 wherein said graphic code comprises a QR code.

47. A system for purchasing products from a locked compartment comprising:
a graphic code associated with said locked compartment that is disposed proximate to said locked compartment;
a smart communicator that scans said graphic code;
an application program downloaded in said smart communicator that processes said graphic code in said smart communicator and generates a compartment identification code and a user identification code, which are transmitted by said smart communicator;
a processor system that receives said compartment identification code and said user identification code and transmits an unlock code if said user identification code and said compartment identification code match a list of authorized user identification codes and authorized compartment identification codes;
an electronic lock that receives said unlock code and unlocks said compartment in response to said unlock code;
weight shelves disposed in said compartment that measure product weights of products removed from, and replaced on, said weight shelves and transmit product identification information based upon said weight of said products removed from, and replaced on, said weight shelves to said processor system, which charges and credits an account associated with said smart communicator.

48. The system of claim 47 wherein said graphic code is a QR code.

49. The system of claim 48 wherein said smart communicator comprises a smart phone.

50. The system of claim 49 wherein said compartment comprises a cooler containing food items.

51. The system of claim 49 wherein said compartment comprises an enclosure containing non-food items.

52. The system of claim 47 wherein said processor system comprises a processor system disposed in said locked compartment.

53. The system of claim 47 wherein said processor system comprises a processor system disposed in a server.

54. The system of claim 47 wherein said processor system comprises a processor system disposed in an Internet cloud.

55. The system of claim 47 wherein said processor system comprises a processor system disposed in a control center.

56. A system for purchasing products from a locked compartment comprising:
at least one weight shelf disposed in said locked compartment that generates a weight measurement signal that indicates when said products have been removed or replaced on said weight shelf;
a camera that records an image for recognition of a user of said locked compartment;
a processing system that analyzes said image to produce analyzed image data, compares said analyzed image with stored image data to recognize said user, determines if said user has an authorized account, generates an unlock signal, determines the number and types of products removed from said weight shelf based upon said weight measurement signal and charges said account of said user for said products removed from said weight shelf;
an electronic lock that unlocks a door on said locked compartment to allow said user to access said products in said locked compartment.

57. The system of claim 56 wherein said image is an image of a user's face and said processing system analyzes said image of said user's face using optical pattern recognition techniques.

58. The system of claim 56 wherein said image is an image of a coded object and said processing system analyzes said image of said object using optical pattern recognition techniques.

59. The system of claim 58 wherein said object is a lapel pin.

60. The system of claim 58 wherein said object is an optically encoded card.

61. A system for unlocking an access port using an automated control system comprising:
a graphic code associated with said access port that is disposed at least proximate to said access port;
a smart communicator that scans said graphic code;
an application program downloaded in said smart communicator that processes said graphic code and generates an access port identification code and a user identification code that are transmitted by said smart communicator;
a control center that receives said access port identification code and said user identification code and transmits an unlock code to said access port to unlock said access port if said access port identification code and said user identification code match an authorized access port identification code and an authorized user identification code in an authorized list of access port identification codes and authorized user identification codes.

62. The system of claim 61 wherein said smart communicator comprises a smart phone.

63. The system of claim 62 wherein said access port comprises a door to an office.

64. The system of claim 62 wherein said access port comprises a door to a house.

65. The system of claim 62 wherein said access port comprises a door to a safe.

66. The system of claim 62 wherein said access port comprises a hotel door.

67. The system of claim 62 wherein said graphic code comprises a QR code.

68. A weight measuring hanger apparatus for purchasing products comprising:
a hanger rod;
a bracket having at least one hook so that said at least one hook attaches to a substantially vertical surface;
a load cell disposed in said hanger rod that detects the weight of said products on said hanger rod and provides an electrical weight measuring signal that detects removal of said products from said sensor rod;
a cover disposed on said weight sensor to protect said at least one load cell.

69. The weight measuring hanger apparatus of claim 68 further comprising:
a raised portion on said hanger rod so that said raised portion prevents said products from sliding off of said hanger rod.

70. A method of purchasing products from a weight measuring hanger comprising:
providing a hanger rod having a bracket;
securing said bracket on a substantially vertical surface using at least one hook disposed on said bracket;
providing at least one load cell disposed in a weight sensor, said weight sensor being disposed in said hanger rod and measuring the weight of said products on said hanger rod;
detecting removal of said products from said hanger rod by detecting a change in weight of said products on said hanger rod;
charging an identified purchaser for said products removed from said hanger rod based upon said change in weight of said products on said hanger rod.

71. The method of claim 70 further comprising:
providing a raised portion on said hanger rod so that said raised portion prevents said products from sliding off of said hanger rod.

72. A shelf for measuring weights of products placed on said shelf and generating electronic data indicating the number of products removed and replaced on said shelf comprising:
a bottom plate;
a plurality of weight sensors that generate an electronic signal that varies with a weight detected by said weight sensors;
a top plate that rests on said weight sensors that provides a surface for placing said products;
a processor that receives said electronic signal and generates a weight signal indicative of a total weight of products disposed on said top plate.

73. The shelf of claim 72 further comprising:
a display that provides information to a user of said shelf.

74. The shelf of claim 73 further comprising:
a wireless transceiver that transmits and receives information to and from a server.

75. The shelf of claim 74 further comprising:
an identification reader that receives a radio frequency signal that identifies a user.

76. The shelf of claim 74 further comprising:
a camera that generates an image of a user to identify said user by processing said image in said processor.

77. A shelf that provides multiple weight measurements comprising:
a shelf surface plate having a plurality of openings;
a plurality of weight sensors attached to said shelf surface plate through said openings;
a plurality of weight sensing plates having a first surface that provides a surface for placing items, and a second surface that rests on said plurality of weight sensors;
a display unit coupled to said plurality of weight sensors that displays information regarding items removed and replaced on said plurality of weigh sensing plate.

78. The shelf of claim 77 wherein said display unit comprises:
a display that displays information regarding items removed and replaced on said plurality of weight sensing plates;
a processor that receives electrical signals from said plurality of weight sensors and generates weight signals.

79. The shelf of claim 78 further comprising:
a multiplexer that sends and receives data between said plurality of weight sensors and said display unit.

80. The shelf of claim 79 further comprising:
a plurality of weight sensor probes that are disposed against said plurality of weight sensors and that extend through said openings to support said plurality of weight sensing plates.

81. An automated purchasing system that allows purchasers to purchase products from a locked compartment comprising:
a plurality of weight sensing shelves disposed in said locked compartment that display said products for sale and generate weight information relating to said products that are removed from said weight sensing shelves;
wireless identifiers that identify said purchasers;
wireless identification readers that read said wireless identifiers and generate purchaser information;
a processor that receives said purchaser information and generates an unlock signal based upon said purchaser information, and receives said weight information relating to products removed from said shelves to charge said purchaser for said products removed from said shelves;
an electronic lock that receives said unlock signal and unlocks said locked compartment in response to said unlock signal.

82. The automated purchasing system of claim 81 wherein said purchaser information comprises purchaser identification information and funds balance information that is carried on said wireless identifiers.

83. The automated purchasing system of claim 81 wherein said purchaser information comprises purchaser identification information and purchaser account information for a monetary account that is associated with said purchaser identification information.

84. The automated purchasing system of claim 82 wherein said weight sensing shelves generate weight information relating to said products that are removed from and replaced on said weight sensing shelves.

85. A method of purchasing products from a locked compartment comprising:
scanning a wireless identifier with a wireless identification reader associated with said locked compartment to generate purchaser identification information that identifies a purchaser;
processing said purchaser identification information and generating an unlock signal based upon at least said purchaser identification information;
transmitting said unlock signal to said compartment to unlock said compartment and allow access to said products placed on weight measuring shelves disposed in said compartment;
measuring the weight of said products removed from said weight measuring shelves;
identifying products removed from said weight measuring shelves based upon said weight of said products removed from said weight measuring shelves;
charging said purchaser for said products removed from said weight measuring shelves.

86. The method of claim 85 further comprising:
locking said compartment after said products have been removed from said weight measuring shelves.

87. The method of claim 86 wherein said process of scanning a wireless identifier comprises:
scanning a radio frequency identification card with a wireless identifier reader.

88. The method of claim 87 wherein said process of scanning a wireless identifier comprises:
scanning a near field communicator device with said wireless identifier reader.
